(19) United States
(12) Patent Application Publication
(10) Pub. No.: US 2007/0099185 A1
(43) Pub. Date: May 3, 2007

(54) Methods for the identification of agents that modulate the structure and processing of beta-amyloid precursor protein

(75) Inventors: Frederick S. Hagen, Seattle, WA (US); Lars Lannfelt, Stockholm (SE); Par Gellerfors, Lidingo (SE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: BioArctic Neuroscience AB, Lidingo (SE); Icogenex Corporation, Seattle, WA (US)

(21) Appl. No.: 10/533,844

(22) PCT Filed: Nov. 4, 2003
(86) PCT No.: PCT/US03/35294

§ 371 Date: May 4, 2005

Related U.S. Application Data
(60) Provisional application No. 60/424,031, filed on Nov. 4, 2002.

(51) Int. Cl. C40B 30/06; C40B 40/08; C40B 40/10

(52) U.S. Cl. 435/6; 435/7.1

(57) ABSTRACT

The present invention provides methods for the screening and identification of agents from a large library of molecular structures that can alter the cleavage of amyloid precursor protein (AP). Agents identified by the methods of the present invention that modify the cleavage of APP can be used in the treatment and prevention of Alzheimer's disease. The methods select for and identify effector agents that bind to APP causing a structural change in the structure of APP in such a way that the efficiency of the cleavage of a secretase is modulated. Further, the methods are carried out in an in vivo system that provides for physiological conditions similar or identical to conditions for APP processing. Agents can be selected for their ability to cause a decrease in the amount of B-secretase or β-secretase cleavage of APP, or for an increase in a-secretase cleavage of APP. The agents can be, particularly peptide agents, can be converted into a peptidominetic, an isosteric replacement compound, a D-amino acid analog, or non-peptidyl compound for treating Alzheimer's disease or any other amyloid related or prion related disease. The agents or derivatives thereof can be formulated for intravenous, parenteral, topical, sustained release, intranasal, or inhalation use.

### RELATED APPLICATIONS

The present application claims priority to U.S. Provisional Application Ser. No. 60/424,031, filed Nov. 4, 2002, incorporated herein by reference in its entirety.

### BACKGROUND OF THE INVENTION

The neuropathology of Alzheimer's disease is characterized by the accumulation of extracellular protein deposits in the brain. These deposits include the amyloid containing plaques and amyloid in vessel walls. The major component of an amyloid plaque is a 39-42 amino acid residue self-aggregating peptide called β-amyloid (Aβ). Considerable progress has been made in understanding the mechanisms that cause the disease, especially following the identification of Amyloid Precursor Protein (APP) and presenilin (PS) gene mutations in familial forms of Alzheimer's disease. These mutations lead to increased levels of the Aβ peptide in the brain (Selkoe, Physiological Rev 81:741-766, 2001).

The Aβ peptide is a proteolytic fragment of APP, a transmembrane protein expressed throughout most tissues in the body. FIG. 2 shows the structure of APP, the resulting proteolytic fragments, and the respective processing enzymes known to generate these fragments. The APP protein is processed by at least three different proteases including β-secretase, β-secretase, and γ-secretase. The β-secretase, responsible for the amino-terminal cleavage, was recently identified and cloned (Sinha, et al., Nature 402: 537-540, 1999). This BACE protease preferentially releases Aβ starting at Asp-1 and Glu-11. The γ-secretase cleavage, releasing the carboxyl-termini of APP, apparently occurs in the predicted transmembrane domain of APP. The γ-secretase consists of a complex of proteins, the most important being presenilin 1 (Steiner, Rev. Mol Cell. Biol. 1:217-224,2000).

Cleavage by P-and y-secretase generates the secreted, soluble Aβ peptide. In neurons, only 5% of APP molecules go through the Aβ generating pathway, while 95% of APP molecules are processed by a-secretase, through the non-amyloidogenic pathway, inhibiting Aβ formation (Lammish, et al., Proc. Natl. Acad. Sci. USA 96:3922-3927, 1999). A less abundant and more hydrophobic Aβ species, Aβ1-42, has recently been linked to early pathological changes seen in Alzheimer's disease. Mutations associated with farnilial forms of Alzheimer's disease have been shown to increase the cellular production of Aβ. The Aβ peptide is thus the central key molecule in the pathogenic process leading to Alzheimer's disease, where Aβ forms protofibrils, fibrils, and subsequently amyloid plaques. Thus, increased production or decreased clearance of Aβ initiates a process resulting in amyloid plaque formation and subsequently neuronal degeneration. Recent studies have suggested that aggregates of Aβ called protofibrils may be toxic entities contributing to neuronal death (Gotz et al., Science 293:1491-1495, 2001). Hence, any treatment that lowers Aβ peptide in the brain of Alzheimer patients would be of significant clinical value. FIG. 1 summarizes current knowledge of the disease in a process called the amyloid cascade.

The identification of a molecule (effector) that modifies the structure of a protein and consequently the activity of the protein or its ability to act as a substrate depends on the intrinsic structural nature of the protein and how it interacts with other structures in a biological system. Protein function relies on the amino acid composition of the protein and the three dimensional structure dictated by the amino acid sequence. A protein is acted upon by other proteins and structures in a biological system based on its structure and the structure of other interactive molecule(s). The structure of a protein can be changed by an interaction with another molecule (allosteric interaction), which may increase or decrease the activity of the protein or the susceptibility of being acted upon by another protein. For example, studies of APP mutations located close to the β-secretase cleavage site suggest that local α-helicity contributes to cleavage efficacy presumably by direct interaction of the endoprotease with this structure (Sisodia, Proc. Natl. Acad Sci. USA 89:6075-6079, 1992). Similarly, changes in the amino acid sequence of APP identified as the Swedish mutation (Mullan et al., Nature Genetics 1:345-347, 1992), change the structure of APP and increases processing of APP at the a cleavage site.

Peptides are structures that can interact with a protein to change its structure and consequently the activity of the protein or its susceptibility to being acted upon by another protein. Peptides as structural effectors are attractive because very large structural diverse libraries can easily be generated by recombinant methods and readily screened with procedures that identify preferred phenotypic behavior. These peptide effectors can be used to validate the effectiveness of a structure to cause a desired structural change. The peptide structure can be used as a model compound structure to design and develop, for example, a peptidomimetic structure that would be biologically stable, readily pass over the blood brain barrier, and be suitable for an oral formulation.

Screening methods have been developed to identify peptides that affect cellular processes through specific binding to proteins (herein also referred to as “peptide effectors”). The utility of random peptide libraries is demonstrated by the numerous methods that have been developed to generate and screen large libraries of structurally diverse peptides. In addition to chemical strategies, such methods include systems that rely upon biological generation (see, e.g., Scott and Smith, Science 249:386-390, 1990 (phage display); Kawasaki, U.S. Pat. No. 5,658,754 (in vitro ribosome display); Cull et al, Proc. Natl. Acad. Sci. USA 89:1865-1869, 1992 (random peptide sequences expressed on the C-terminus of the lac repressor); Murray et al., Biotechnology 13:366-372, 1995 (thioredoxin random peptide libraries expressed on the flagellin of E. coli); Brown, Nat. Biotechnol. 15:269-272, 1997 (repeating polypeptides expressed on the surface of bacteria); Gilchrist and Hamm, Methods Enzymol. 315:388-404, 2000 (peptides-on-plasmids); Wilson et al., Proc. Natl. Acad Sci. USA 98:3750-3755, 2001 (mRNA display); Kjaergaard et al., Appl. Environ. Microbiol. 67:5467-5473, 2001 (fimbria-displayed peptide libraries). Most recently, Rigel, Inc. has demonstrated the utility of in vivo introduction of random peptide libraries to identify peptides that alter phenotypic changes in a mammalian cell (See, e.g., Kinsella et a., J. Biol. Chem. 277:37512-37518, 2002).

However, current methods do not allow the identification of peptide effectors that interact with target molecules in cellular secretory pathways and, therefore, are not suited for identification of such peptides that will affect processing of APP during transit through the secretory pathways. Like APP, APP processing enzymes, such as, for example, α-, β-, and γ-secretase, pass through secretory pathways and are also present on the cell surface. While some methods have been developed to screen small peptides and polypeptides intracellularly in the cytoplasm (see, e.g., Fields and Song, Nature 340:245-46, 1989; Cull et al., Proc. Natl. Acad Sci. USA 89:1865-69, 1992; Lu et al., Biotechnology (NY) 13:366-72, 1995; International Patent Publication WO 99/24617; Norman et al., Science 285:591-95, 1999); International Patent Publication WO 98/39483), secreted molecules such as APP and APP processing enzymes are sequestered in compartments that do not mix with most other cytosolic molecules or organelles. For this reason, the current methods do not preserve the native secretory environment of APP.

In addition, current methods suffer from various disadvantages that limit the efficient identification of therapeutically promising agents, including peptides, that act within the extracellular space. Consequently, current methods are also not suited for efficient identification of peptides that affect APP processing on the cell surface. Most of the screening methods that employ conventional peptide libraries (e.g., phage display libraries, combinatorial libraries, peptide mimetic libraries, and one-bead-one structure combinatorial libraries) demonstrate only binding to targets in vitro. The normal structure, activity, and any necessary regulatory molecule(s) may be lost when extracellular proteins are purified or removed from their native, extracellular environment. Thus, these methods often fail to identify peptides that bind to extracellular targets with corresponding physiological effects in vivo.

There is a need for screening methods that identify molecular effectors that specifically bind to APP to alter its processing and reduce the amount of Aβ , rather than identifying agents that generally affect the cleavage activities of the APP processing enzymes. Current methodologies directed at perturbation of enzymatic pathways typically focus on enzyme-based screens. However, APP processing enzymes are involved in other important biological processes. Generally altering the activities of these enzymes, even if reducing the risk of Alzheimer's disease, can also cause other detrimental biological effects. For example, increasing the activity of a-secretase reduces the abundance of Aβ. However, a-secretase is also involved in the formation of angiotensin-converting enzyme (ACE), a regulator of blood pressure (Parvathy et al., Biochemistry 37:1680-1685, 1998). Increasing α-secretase activity increases blood pressure increasing the risk of heart disease.

Further, methods developed to screen small peptides and polypeptides intracellularly in the cytoplasm, while preserving the native, cytosolic constituents of intracellular pathways, do not allow for the screening of peptides that affect APP processing extracellularly under relevant physiological conditions. While other methods have been described that allow peptide library sequences to be expressed extracellularly on eukaryotic cells, including mammalian and other animal cells (see U.S. Pat. No. 6,153,380; International Patent Application WO 98/39483), these methods still do not allow peptide interactions with APP to be screened under physiological conditions, such as in the presence of undiluted blood, plasma, serum, or other complex biological fluids. For example, one method allows randomized peptides to be inserted into host cells and, depending on the fusion construct used, either localized to the extracellular or intracellular cell surface or secreted in soluble form. (See U.S. Pat. No. 6,153,380.) Peptides can then be selected by assaying for their ability to alter the phenotype of either the host cells or, alternatively, of another cell population. While allowing for the identification of peptides that affect extracellular interactions, this method does not address the need for assay conditions that reproduce the physiological conditions native to APP processing. Such conditions, including those that affect molecular conformation, stability, binding kinetics, and the like, can be significant for maintaining normal interactions of APP with other extracellular macromolecules, including APP processing enzymes such as α-secretase, β-secretase, or γ-secretase.

Therefore, there is need for screening methods that identify molecular effectors of APP processing under conditions that preserve the molecular and cellular constituents of APP secretory pathways as well as replicate the complex physiological conditions of the extracellular environment. Because maintaining the complex conditions native to APP processing will reduce non-specific binding events, retain native molecular conformations and kinetics, and maintain the presence of regulatory molecules, the disclosed physiological and secretory-based screens are more likely to identify agents that alter APP processing, including agents that alter the production of Aβ.

The development of such screening methods that preserve the secretory and extracellular conditions important in APP processing, as well as methods that can identify effectors that specifically bind to APP, are needed to facilitate the identification of agents that reduce the amount of Aβ under physiologically relevant conditions and with optimal specificity, thereby facilitating the identification of more effective drugs and therapeutic approaches for the treatment of Alzheimer's Disease. The present invention provides such methods which are further set forth herein.

### SUMMARY OF INVENTION

The present invention generally relates to methods for identifying an agent that alters processing of β-amyloid precursor protein (APP). In one aspect, the method includes contacting the agent with an animal host cell that expresses APP and at least one APP processing enzyme and detecting altered APP processing on the surface of the host cell to identify the agent that alters the processing of APP. APP processing enzyme(s) expressed by the host cell can include, for example, α-secretase, β-secretase, or γ-secretase. The alteration of APP processing detected can be, for example, processing resulting in a decreased production of an amyloid β-protein (Aβ). In addition, the amyloid β-protein demonstrating decreased production as a result of the altered APP processing can be an Aβ protein associated with an increased risk of Alzheimer's disease, such as, for example, Aβ1-39, Aβ1-40, and/or Aβ1-42.

The animal host cell expressing APP and APP processing enzyme(s) can be, for example, a mammalian host cell. The animal host cell can be a recombinant host cell or, alternatively, an isolated host cell expressing endogenous APP and APP processing enzyme(s).

In certain embodiments, detecting the altered APP processing includes assessing the relative presence or absence of at least one species of APP fragment on the surface of the host cell. Species of APP fragments assessed can include, for example, APPs-α, APPs-β, or APPs-γ. The assessment of the relative presence or absence of at least one species of APP fragment can include, for example, contacting the host cell with at least one detectably labeled marker that specifically binds to the species of APP fragment and detecting the bound, labeled marker. Markers for detection of the absence or presence of APP fragments can be, for example, an antibody that binds to a predetermined epitope of APP or APP fragment. In certain embodiments, the assessment of the relative presence or absence of the APP fragment includes determining a ratio of the detection signals of at least two labeled antibodies specific for at least two different epitopes of APP or an APP fragment. Detection of altered APP processing on the surface of the host cell can include, for example, the use of a flow cytometer or cell sorter.

The agent contacted with the host cell can be, for example, a small molecule or a biomolecule. In certain embodiments, the biomolecule contacted with the host cell is a peptide. The agent can come from a compound library such as, for example, a combinatorial chemical library, a natural products library, or a peptide library. The agent can be an allosteric effector of APP.

In certain embodiments, the agent is contacted with the host cell under substantially physiological conditions. Substantially physiological conditions can include the presence of a complex biological fluid, such as, for example, blood, serum, plasma, or cerebral spinal fluid (CSF).

In embodiments where the host cell is contacted with a peptide, the peptide can be produced, for example, by transcription and translation from an oligonucleotide encoding the peptide. The length of the oligonucleotides encoding the peptide can be, for example, about 18 to about 120 nucleotides, 21 to about 60 nucleotides, or about 36 to about 60 nucleotides. In one embodiment, the contacting of the peptide with the host cell includes introducing an expression vector, the expression vector including the oligonucleotide encoding the peptide, into the host cell. The host cell into which the expression vector is introduced expresses and displays the peptide within the secretory pathway and on the cell surface.

The oligonucleotides introduced into the host cell can be, for example, from an expression library that includes oligonucleotide inserts, a majority of these oligonucleotides having different sequences encoding different peptides. In certain embodiments, the sequence of the oligonucleotides is randomized. The expression library is introduced into animal host cells that express APP and at least one APP processing enzyme. Host cells into which the expression library is introduced express and display the different peptides within the secretory pathway and on the cell surface. In certain embodiments, the different peptides are displayed by the host cells under substantially physiological conditions.

In other embodiments, a subset of host cells exhibiting altered APP processing are selected from the host cells. From this subset of host cells, a sub-library of the expression library is identified, the sub-library including at least one oligonucleotide that encodes a peptide that alters the processing of APP.

In certain embodiments, the host cells into which the expression library is introduced can be enriched for host cells displaying the different peptides. The host cells can be enriched by including a selectable marker in the expression construct. The expression construct can be, for example, V5, FLAG, Protein A, or thioredoxin. Selection for the marker can include, for example, magnetic bead selection fluorescence-activated cell sorting. In certain embodiments, host cells enriched for cell displaying peptides can express a high copy number of the different peptides.

In one embodiment, the peptide is displayed as a fusion protein with a presentation molecule. The presentation molecule can be, for example, CD24, IL-3 receptor, protein A or thioredoxin, and the like. The fusion protein can further include a marker epitope, such as, for example, polyhistidine, V5, FLAG or myc, and the like. The fusion protein can also include a signal for a glycophosphatidylinositol (GPI) anchorage.

In other embodiments, the expression library can be pre-enriched for oligonucleotide(s) encoding peptides that specifically bind to APP prior to introduction of the library into the host cells. Pre-enrichment can include introducing the expression library into a phage display vector which can express the peptides encoded by the oligonucleotide sequences on the surface of the phage; expressing the different peptides on the surface of the phage; selecting a subset of phage particles that express peptides that specifically bind APP; and recovering the oligonucleotide sequences from the selected phage particles. The pre-enriched expression library can be introduced into animal host cells expressing APP and at least one APP processing enzyme. Host cells into which a pre-enriched library has been introduced express and display APP-binding peptide(s) within the secretory pathway and on the extracellular cell surface. A subset of host cells that exhibit altered APP processing is selected from host cells expressing the pre-enriched library. From this subset of host cells, a sub-library of the pre-enriched expression library is identified, the sub-library including at least one oligonucleotide that encodes an APP-binding peptide that alters the processing of APP.

A further understanding of the nature and advantages of the invention will become apparent by reference to the remaining portions of the specification.

### BRIEF DESCRIPTION OF THE DRAWING

FIG. 1 depicts the arnyloid cascade leading to Alzheimer's disease.

FIG. 2 depicts a schematic diagram of the β-amyloid precursor protein (APP) and its principal metabolic derivatives. The top diagram depicts the largest of the known APP alternative spliced forms, comprising 770 amino acids. A single transmembrane domain (TM) at amino acids 700-723 is indicated by vertical dotted lines. The β-amyloid (Aβ) fragment includes 28 amino acids outside the membrane plus the first 12-14 residues of the TM domain. Arrows indicate sites of the proteolytic cleavage by processing enzymes. The various proteolytic fragments are labeled. (Selkoe, Physiological Rev. 81:741-767, 2001).

FIG. 3 depicts a representation of the expression cassette for the expression of random peptide and presentation protein for the retroviral construction for the identification of effector peptides of APP.

FIG. 4 depicts a representation of the presentation protein being expressed on the surface of a cell with random peptide sequence in the configuration of a cysteine loop.

FIG. 5 depicts APP on the surface of a cell with labeled fragments, cleavage sites, antibodies recognizing fragments of APP, and strategies of using ratios of fluorescence to detect altered processing of APP.

FIG. 6 depicts a representation of one example of an expression vector, designated pIcoDual, encoding a CD24 V5 fusion protein and a thioredoxin-FLAG fusion protein, which is suitable for use in the present invention.

FIG. 7 depicts a representation of an expression vector designated pIcoFLAGXa, encoding a CD24 V5 fusion protein and a thioredoxin-FLAG fusion protein where the DNA encoding the Factor Xₐ amino acid substrate sequence, Ile-Glu-Gly-Arg-X (SEQ ID NO:5), has been inserted at the site encoding the random peptide sequence.

FIG. 8 depicts a representation of Thy1-EMα/EMβs (S) and Thy1-EMα/EMβ_{M} (M) expression constructs for in vivo expression of effector peptides in transgenic mice. “EMα/EMβ sequence” denotes a nucleotide coding sequence for either an EMα peptide (i.e., an effector peptide that stimulates APP processing by α-secretase) or an EMβ peptide (ie., an effector peptide that inhibits APP processing by β-secretase).

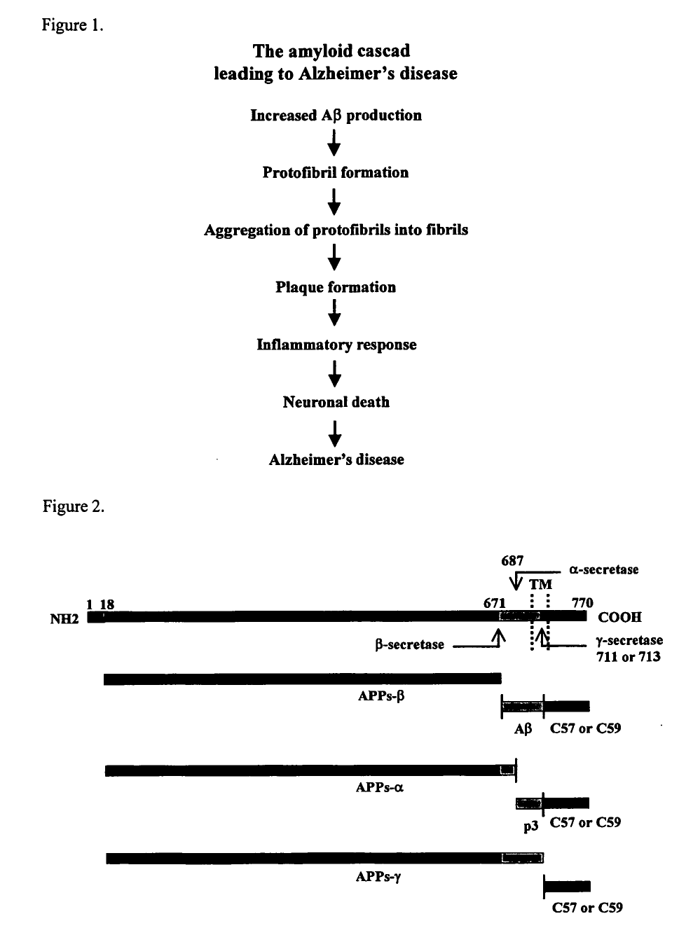

### DESCRIPTION OF THE SPECIFIC EMBODIMENTS

The present invention provides screening methods for the identification of molecules and agents, including peptides and other small molecules, that alter processing of β-amyloid precursor protein (APP) and that thereby alter the production of β-amyloid (Aβ). The screening methods provided allow for the identification of effector agents that can increase or decrease cleavage of cellular APP at processing enzyme cleavage sites that correlate with the production of Aβ. These screening methods can facilitate the development of therapeutic molecules for the treatment of Alzheimer's Disease (AD) that correct or partially correct imbalances in the activities of APP processing enzymes, such as α-secretase, β-secretase, or γ-secretase, that are implicated in the cause of AD.

Prior to setting forth the invention in more detail, it may be helpful to a further understanding thereof to set forth definitions of certain terms as used hereinafter.

Definitions

The terms “APP processing enzyme” refers to proteolytic enzymes involved in post-translational modification of amyloid precursor protein (APP) during transience through secretory pathways in a cell (including, e.g., the trans Golgi network and secretory vesicles) or on the extracellular cell surface. Proteolytic processing of APP affects the relative amount of Aβ produced by the cell. APP processing enzymes include, for example, α-secretase, β-secretase, and γ-secretase.

The term “altered APP processing” refers to a change in the relative amounts of one or more APP fragments produced by a cell. APP fragments include, for example, APPs-α, APPs-β, and APPs-γ (see FIG. 2). Because the relative amount of one or more APP fragments is correlative of the amount of Aβ produced, “altered APP processing” as used herein also generally refers to changes in APP processing that result in a change in the amount of Aβ produced by a cell.

The terms “agent,” “molecule,” and “compound” as used herein are synonymous and refer generally to molecules potentially capable of structural interactions with cellular constituents through non-covalent interactions, such as, for example, through hydrogen bonds, ionic bonds, van der Waals attractions, or hydrophobic interactions. For example, agents will most typically include molecules with functional groups necessary for structural interaction with proteins, glycoproteins, and/or other macromolecules, particularly those groups involved in hydrogen bonding.

Agents can include small organic molecules such as, for example, aliphatic carbon or cyclical carbon (e.g., heterocyclic or carbocyclic structures and/or aromatic or polyaromatic structures, and the like). These structures can be substituted with one or more functional groups such as, for example, an amine, carbonyl, hydroxyl, or carboxyl group. In addition, these structures can include other substituents such as, for example, hydrocarbons (e.g., aliphatic, alicyclic, aromatic, and the like), nonhydrocarbon radicals (e.g., halo, alkoxy, acetyl, carbonyl, mercapto, sulfoxy, nitro, amide, and the like), or hetero substituents (e.g., those containing non-carbon atoms such as, for example, sulfur, oxygen, or nitrogen).

Agents can also include biomolecules. “Biomolecules” refer to classes of molecules that exist in and/or can be produced by living systems as well as structures derived from such molecules. Biomolecules typically include, for example, proteins, peptides, saccharides, fatty acids, steroids, purines, pyrimidines, and derivatives, structural analogs, or combinations thereof. Biomolecules can include one or more functional groups such as, for example, an amine, carbonyl, hydroxyl, or carboxyl group.

Agents include those synthetically or biologically produced and can include recombinantly produced structures such as, for example, peptide-presenting fusion proteins. The term “fusion protein” refers to a polymer of amino acids produced by recombinant combination of two or more sequence motifs and does not refer to a specific length of the product; thus, a fusion protein can include a peptide sequence joined to an affinity label such as, for example, 6-histidine.

The terms “effector agent” or “molecular effector” as used herein refer to molecules that affect protein interactions with other macromolecules. “Molecular effector of APP processing” thus refers to a molecule that alters APP processing through, for example, interactions with APP or APP processing enzymes.

The term “specific binding” refers to the direct interaction between an agent and APP. An interaction between the agent and APP can be detected either by direct or indirect analysis.

The term “allosteric effector” refers to an effector agent that activates or inhibits a particular protein activity or interaction by specifically binding to the protein to change its conformation. “Allosteric effector of APP” thus refers to an agent that specifically binds to APP and changes its conformation such that processing by one or more APP processing enzymes is altered. The specific binding site of an allosteric effector is referred to herein as an “allosteric site.”

The term “N-terminally truncated APP” as used herein refers to a form of the APP polypeptide that is truncated at the N terminus at a site N-terminal to the α-and/or β-secretase cleavage sites. These N-terminally truncated forms include, for example, polypeptides encoded by a region of the APP coding sequence beginning at nucleotide 457 just 3′ to the Kunitz protease inhibitor domain sequence, another at nucleotide 550, and various shorter forms that exclude the N-terminal functional groups but include the random coil sequence near the β cleavage site to amino acid residues outside of the membrane.

The term “host cell” refers to a cell that can serve as a vehicle to test effector agents that can be introduced by several means. Host cells suitable for the present invention are those that express APP and one or more APP processing enzymes, e.g., α-, β-, and/or γ-secretase. In addition, suitable host cells for use in the present invention typically are animal cells, particularly mammalian cells. Host cells can also be “recombinant host cells.” The term “recombinant host cell” as used herein means a host cells that expresses one or more recombinant proteins, including, for example, recombinant APP and/or one or more APP processing enzymes. Examples of suitable host cells include human embryonic kidney (HEK) cells, human neuroblastoma cell lines, Ba/F3, AC2 (see, e.g., Garland and Kinnaird, Lymphokine Res. 5:S145-S150 (1986)), B9, HepG2, MES-SA and MES-SA/Dx5 cells. The host cell can serve as a recipient for a genetic library that is introduced by any one of several procedures. The host cell serving as a recipient of a genetic library often allows replication and segregation of a vector containing a library insert. In certain embodiments, however, replication and segregation are irrelevant; expression of a library insert is all that is required.

The terms “genetic library” refers to a collection of nucleic acid fragments that can individually range in size from about a few base pairs to about a million base pairs. Typically, as used in the context of the present invention, a genetic library comprises random or semi-random oligonucleotides that encode peptides or polypeptides. The oligonucleotides can have an average length of, for example, from about 10 bases to about 60 bases. In certain embodiments, a library is contained as inserts in a vector capable of propagating in certain host cells, such as bacterial and/or mammalian cells.

The term “compound library” as used herein refers to any collection of agents that includes a plurality of molecular structures. Compound libraries can include, for example, combinatorial chemical libraries, natural products libraries, and peptide libraries, further described infra. In certain embodiments, peptide libraries can be generated by transcription and translation from nucleic acid sequences included within a genetic library.

The term “sub-library” refers to a portion of a compound library or genetic library that has been isolated by methods according to the present invention.

The term “insert” in the context of a genetic library refers to an individual nucleic acid fragment that is typically inserted into a single vector (e.g., an expression vector) or an expression construct.

The term “coverage” in the context of a genetic library refers to the amount of redundancy of the genetic library. It will be appreciated by those skilled in the art that the redundancy of a genetic library is generally related to the probability that a specific sequence is actually present within the nucleic acid sequences of that library. Coverage is the ratio of the number of library inserts, such as peptide-encoding oligonucleotides, multiplied by the average insert size divided by the total complexity of the nucleic acid sequences that the library represents.

The term “vector” refers to a nucleic acid sequence that is capable of propagating in a particular host cell and that can accommodate inserts of heterologous nucleic acid. Typically, vectors are manipulated in vitro to insert heterologous nucleic acids into a cloning site. A vector can be introduced into a host cell in a stable or transient manner, such as by transformation, transfection, or infection by a viral vector.

The term “expression vector” refers to a vector designed to express an inserted nucleic acid. Such vectors can contain, for example, one or more of the following operably associated elements: a promoter located upstream of the insertion site (e.g., a cloning site) of the nucleic acid, a transcription termination signal, a translation termination signal and/or a polyadenylation signal. An expression vector can also include a selectable marker, such as a drug resistance gene (e.g., hygromycin or neomycin resistance). (See, e.g., Santerre et al., Gene 30:147-156 (1984).) The expression vector can also include sequences for packaging into viral particles.

The term “high copy number” refers to expression on an extracellular surface of a host cell of at least several hundred to several thousand molecules encoded by a library insert.

The term “expression” in the context of a nucleic acid refers to transcription and/or translation of the nucleic acid into mRNA and/or protein.

The term “expression library” refers to a plurality of copies of an expression construct or vector, a majority of the copies of the construct or vector containing inserts of nucleic acid fragments from the genetic library.

The term “presentation molecule” refers to a polypeptide that can be used to display a peptide or polypeptide as part of a fusion protein.

The term “stable expression” refers to the continued presence and expression of a nucleic acid sequence in a host cell for a period of time that is at least as long as that required to carry out the methods according to the present invention. Stable expression can be achieved by integration of the nucleic acid into a host cell chromosome, or engineering the nucleic acid so that it possesses elements that ensure its continued replication and segregation within the host (e.g., an expression vector or an artificial chromosome) or alternatively, the nucleic acid can contain a selectable marker (e.g., a drug resistance gene) so that stable expression of the nucleic acid is ensured by growing the host cells under selection conditions (e.g., drug-containing medium) or it can be introduced as a viral genome that becomes integrated in the host genome.

The term “specific binding” refers to the direct interaction between an agent and APP. An interaction between the agent and APP can be detected either by direct or indirect analysis.

The terms “physiological conditions” and “substantially physiological conditions” refer to conditions that are normally present, or that substantially approximate those normally present, in an extracellular space, on an extracellular surface (e.g., on a cell membrane), in a Golgi network, secretory vesicle, and/or in a complex biological fluid. For example, “substantially physiological conditions” can be those present when extracellular targets are active or express their activities (e.g., enzymatic activity, binding to a receptor, substrate, scaffolding molecule, or other binding partner, and the like).

The term “complex biological fluid” refers to a biological fluid, such as, for example, autologous (i.e., from the same animal), homologous (i.e., from an animal of the same species), or heterologous (i.e., from a different species) blood, plasma, serum, cerebral spinal fluid (CSF), and the like. Complex biological fluids can be either undiluted or substantially undiluted. The term “substantially undiluted complex biological fluid” refers to a complex biological fluid that is either undiluted or diluted in physiological buffers to typically no less than about 50% concentration. Substantially undiluted complex biological fluids, i.e., no less than approximately 50% of undiluted fluids, have substantially the same ionic composition and strength and substantially the same macromolecular structures in solution, in approximately the same absolute concentrations, as the undiluted fluid.

The terms “transformation” or “transfection” refer to the process of introducing nucleic acids into a recipient (e.g., host) cell. This is typically detected by a change in the phenotype of the recipient cell. The term “transformation” is generally applied to microorganisms, while “transfection” is used to describe this process in cells derived from multicellular organisms.

The terms “infect” or “infected” refer to the process of introducing nucleic acids into a recipient (e.g., host) cell by means of a viral vector.

The term “flow sorter” refers to a device that analyzes light emission intensity from cells or other objects and separates these cells or objects according to parameters such as light emission intensity. Suitable flow sorters include, for example, a fluorescence-activated cell sorter (FACS), a spectrophotometer, microtiter plate reader, a charge coupled device camera and reader, a fluorescence microscope, or similar device.

The terms “bright” and “dim” in the context of a flow sorter refer to the intensity levels of fluorescence (or other modes of light emission) exhibited by particular cells: Bright cells have high intensity emission relative to the bulk population of cells and, by inference, high levels of reporter; dim cells have low intensity emission relative to the bulk population and, by inference, low levels of reporter.

The term “bead selection” refers to the use of beads to selectively remove cells from a mixture of cells. Beads can include a macromolecule, such as an antibody or other binding partner. In certain embodiments, the bead selection uses derivatized magnetic beads. For example, cells expressing a FLAG epitope on the cell surface can be pre-selected on magnetic beads that are coated with anti-FLAG antibody. The magnetic beads can then be collected using a strong magnetic field.

Selection/Establishment of Host Cell Lines

The host cells used in the screening methods according to the present invention express both APP and one or more APP processing enzyme, such as α-secretase, β-secretase, or γ-secretase These host cells can be isolated cells that endogenously express APP and/or at least one of the APP processing enzymes. In addition, the host cells can be recombinant host cells expressing recombinant forms of APP, including, for example, a N-terminally truncated APP, and/or at least a recombinant form of one processing enzyme. Host cells can, therefore, exhibit endogenous expression with respect to one such APP or enzyme molecule while being a “recombinant host cell” with respect to another such molecule.

In one exemplary embodiment of the invention, the host cells are recombinant with respect to APP and contain endogenous α-secretase, β-secretase, and γ-secretase. DNA encoding APP can be obtained, for example, from the American Type Culture Collection (ATCC) or the Innovative Molecular Analysis Technologies Program of the National Cancer Institute, National Institutes of Health (IMAT) or are alternatively obtained by methods known in the art such as, e.g., PCR amplification and DNA sequence analysis verification. The cDNA can be inserted into, e.g., a mammalian expression vector and transfected into a parental mammalian cell line (e.g., a neuroblastoma cell line or human embryonic kidney cell line (HEK)) using known methods such as, for example, electroporation. These cell lines can be assessed for APP expression using methods known in the art such as, for example, fluorescent microscopy or FACS analysis using anti-APP antibodies. For example, antibodies to various APP fragments are known, including APPs-β (such as for example, A3 or 1G7 specific to APP midregion, Koo et al., J. Biol. Chem. 269:17386-17389, 1994), APPs-α (e.g., 6E10, Pirttila et al., Neurol Sci. 127:90-95, 1994, McLaurin et al., Nature Med 8:1263-1269, 2002, specific for the carboxyl terminal end of APPs-α or the region of APP between the β and α cleavage sites), and p3 (e.g., 4G8, Pirttila et al., Neurol Sci. 127:90-95, 1994, McLaurin et al., Nature Med. 8:1263-1269, 2002).

In other embodiments, these cells can then be transfected with one or more expression vectors, each expression vector encoding one or more APP processing enzymes. For example, two separate expression vectors, one encoding α-secretase and the other encoding either β-secretase or γ-secretase, can be transfected into the host cells. DNA encoding the secretases can be obtained, for example, from ATCC or IMAT or are alternatively obtained by methods known in the art such as, e.g., PCR amplification and DNA sequence analysis verification.

Compound Libraries

In one embodiment of the invention, compound libraries are contacted with host cells to screen for effector agents that alter APP processing. Compound libraries can be prepared from, for example, a historical collection of compounds synthesized in the course of pharmaceutical research; libraries of compound derivatives prepared by rational design (see generally, Cho et al., Pac. Symp. Biocompat. 305-316, 1998; Sun et al., J. Comput. Aided Mol. Des. 12:597-604, 1998; each incorporated herein by reference in their entirety), such as, for example, by combinatorial chemistry (see discussion of combinatorial chemical libraries, infra); natural products libraries (libraries including, for example, complex extracts derived from microorganisms such as bacteria, algae, fingi, yeasts, molds, various plants or plant parts, animal fluids, secretions and the like, and others; such libraries can, for example, include those formed in the course of pharmaceutical research); peptide libraries (see discussion of peptide libraries, infra); and the like.

Combinatorial Chemical Libraries: In other embodiments, compound libraries can be prepared by syntheses of combinatorial chemical libraries (see generally DeWitt et al., Proc. Natl. Acad. Sci. USA 90:6909-6913, 1993; International Patent Publication WO 94/08051; Baum, Chem. & Eng. News, 72:20-25, 1994; Burbaum et al., Proc. Natl. Acad. Sci. USA 92:6027-6031, 1995; Baldwin et al., J. Am. Chem. Soc. 117:5588-5589, 1995; Nestler et al., J. Org. Chem. 59:4723-4724, 1994; Borehardt et al., J. Am. Chem. Soc. 116:373-374, 1994; Ohlmeyer et al., Proc. Natl. Acad. Sci. USA 90:10922-10926, 1993; and Longman, Windhover's In Vivo The Business & Medicine Report 12:23-31, 1994; all of which are incorporated by reference herein in their entirety.)

The following articles describe methods for selecting starting molecules and/or criteria used in their selection: Martin et al., J. Med. Chem. 38:1431-1436, 1995; Domine et al., J. Med. Chem., 37:973-980, 1994; Abraham et al., J. Pharm. Sci. 83:1085-1100, 1994; each of which is hereby incorporated by reference in its entirety. Methods of making combinatorial libraries are known in the art, and include the following: U.S. Pat. Nos. 5,958,792; 5,807,683; 6,004,617; 6,077,954 which are incorporated by reference herein.

A “combinatorial library” is a collection of compounds in which the compounds of the collection are composed of one or more types of subunits. The subunits can be selected from natural or unnatural moieties, including dienes, aromatic or polyaromatic compounds, alkanes, cycloalkanes, lactones, dilactones, amino acids, and the like. The compounds of the combinatorial library differ in one or more ways with respect to the number, order, type or types of modifications made to one or more of the subunits comprising the compounds. Alternatively, a combinatorial library may refer to a collection of “core molecules” which vary as to the number, type or position of R groups they contain and/or the identity of molecules composing the core molecule. The collection of compounds is typically generated in a systematic way. Any method of generating a collection of compounds differing from each other in one or more of the ways set forth above can be a combinatorial library.

A combinatorial library can be synthesized on a solid support from one or more solid phase-bound resin starting materials. The library can contain ten (10) or more, typically fifty (50) or more, organic molecules which are different from each other (i.e., ten (10) different molecules and not ten (10) copies of the same molecule). Each of the different molecules (different basic structure and/or different substituents) will be present in an amount such that its presence can be determined by some means (e.g., can be isolated, analyzed, detected with a binding partner or suitable probe). The actual amounts of each different molecule needed so that its presence can be determined can vary due to the procedures used and can change as the technologies for isolation, detection and analysis advance. When the molecules are present in substantially equal molar amounts, an amount, for example, of 100 picomoles or more can be detected. Typical libraries include substantially equal molar amounts of each desired reaction product and typically do not include relatively large or small amounts of any given molecule(s) so that the presence of such molecules dominates or is completely suppressed in any assay.

Combinatorial libraries are generally prepared by derivatizing a starting compound onto a solid-phase support (such as a bead). In general, the solid support has a commercially available resin attached, such as a Rink or Merrifield Resin. After attachment of the starting compound, substituents are attached to the starting compound. For example, an aromatic (e.g., benzene) compound can be bound to a support via a Rink resin. The aromatic ring is reacted simultaneously with a substituent (e.g., an amide). Substituents are added to the starting compound, and can be varied by providing a mixture of reactants to add the substituents. Examples of suitable substituents include, but are not limited to, the following:

(1) hydrocarbon substituents, that is, aliphatic (e.g., alkyl or alkenyl), alicyclic (e.g., cycloalkyl or cycloalkenyl, and the like) substituents, aromatic, aliphatic and alicyclic-substituted aromatic nuclei, and the like, as well as cyclic substituents;

(2) substituted hydrocarbon substituents, that is, those substituents containing non-hydrocarbon radicals which do not alter the predominantly hydrocarbon substituent; those skilled in the art will be aware of such radicals (e.g., halo (especially chloro and fluoro), alkoxy, mercapto, alkylmercapto, nitro, nitroso, sulfoxy, and the like);

(3) hetero substituents, that is, substituents that will, while having predominantly hydrocarbyl character, contain other than carbon atoms. Suitable heteroatoms will be apparent to those of ordinary skill in the art and include, for example, sulfur, oxygen, nitrogen, and such substituents as pyridyl, furanyl, thiophenyl, imidazolyl, and the like.

Natural Products Library: In another embodiment of the invention, the compound library is a natural products library. The natural products library can be, for example, a library of natural products from diverse natural products sources (e.g., such as those natural products accumulated during the course of pharmaceutical research) or, alternatively, a collection of compounds derived from a single natural products source (for example, one or more lysates, homogenates, or chemical extracts from, e.g., microorganisms, plants, animal fluids, or other biological material such as that found in, e.g., soil or peat).

In one embodiment, the source for generating the natural products library is a peat material. These materials commonly contain very large numbers of diverse compounds. In one specific embodiment, the natural products library is derived from a peat material obtained from Bonaparte Meadows, a peat bog near Bonaparte Lake, Washington, U.S.A. (See U.S. Pat. No. 6,267,962.) Procedures related to the use and screening of peat material for certain uses are generally known in the art. (See, e.g., U.S. Pat. Nos. 6,267,962 and 6,365,634, incorporated herein by reference in their entirety.) For example, one general scheme of peat material extraction and fractionation involves an initial exposure to ethanol to extract molecules with a broad range of characteristics from non-polar to polar properties. Subsequent fractions can include, for example, those that are acidified or alkalinized and subjected to phase separations with, e.g., chloroform. Resulting fractions can be further fractionated by, e.g., silica gel chromatography and/or reverse phase HPLC. Once a desired fraction is obtained, it can be buffer exchanged using, e.g., standard procedures to facilitate its use according the particular screening method used.

Peptide Libraries: In one embodiment, the compound library is a peptide library. Generally, peptides ranging in size from about 4 amino acids to about 100 amino acids can be used, with peptides ranging from about 6 or 7 to about 40 being typical and with from about 7 to about 20 being more typical.

In certain embodiments, the library can comprise synthetic peptides. For example, a population of synthetic peptides representing all possible amino acid sequences of length N (where N is a positive integer), or a subset of all possible sequences, can comprise the peptide library. Such peptides can be synthesized by standard chemical methods known in the art (see, e.g., Hunkapiller et al., Nature 310:105-111, 1984; Stewart and Young, Solid Phase Peptide Synthesis, 2^{nd} Ed., Pierce Chemical Co., Rockford, Ill., (1984)), such as, for example, an automated peptide synthesizer. Furthermore, if desired, non-classical amino acids or chemical amino acid analogs can be used in substitution of or in addition into the classical amino acids. Non-classical amino acids include but are not limited to the D-isomers of the common amino acids, α-amino isobutyric acid, 4-aminobutyric acid, 2-amino butyric acid, γ-amino butyric acid, 6-amino hexanoic acid, 2-amino isobutyric acid, 3-amino propionic acid, ornithine, norleucine, norvaline, hydroxyproline, sarcosine, citrulline, cysteic acid, t-butylglycine, t-butylalanine, phenylglycine, cyclohexylalanine, β-alanine, selenocysteine, fluoro-amino acids, designer amino acids such as β-methyl amino acids, C α-methyl amino acids, N α-methyl amino acids, and amino acid analogs in general. Furthermore, the amino acid can be D (dextrorotary) or L (levorotary).

In other embodiments, the peptide libraries can be produced by transcription and translation from a library of nucleic acid sequences. In one exemplary embodiment, an expression library comprising oligonucleotides encoding the library peptides is introduced into a host cell (see Genetic Libraries, Expression Cassettes and Vectors, and Nucleic Acid Transfer, infra).

Genetic Libraries

In one aspect of the invention, the screening methods include introducing an expression library into a host cell that expresses APP and one or more APP processing enzyme(s).

The genetic libraries according to the present invention include a collection of at least partially heterogeneous nucleic acid fragments. Such nucleic acid fragments can include, for example, synthetic DNA or RNA, genomic DNA, cDNA, mRNA, cRNA, heterogeneous RNA, and the like. The nucleic acid fragments can represent, for example, all or some portion of a population of nucleic acids, such as a genome, of a population of mRNAs, or some other set of nucleic acids that contain nucleic acid sequences of interest. The genetic libraries contain sequences in a form that can be manipulated.

The present invention typically uses genetic libraries that are derived from synthetic DNA or from fragments of genomic DNA and/or cDNA from a particular organism. Such library sequences will typically range from about 10 bases to about 10 kilobases. The library sequences can optionally be oligonucleotides having, for example, an average length of from about 10 bases to about 60 bases.

Methods of making synthetic DNA are known to those of skill in the art. (See, e.g., Glick and Pasternak, Molecular Biotechnology: Principals and Applications of Recombinant DNA, ASM Press, Washington, D.C. (1998).) Methods of making randomly sheared genomic DNA and/or cDNA, and of manipulating such DNA's, are also known in the art. (See, e.g., Sambrook et al., Molecular Cloning, A Laboratory Manual, 3rd ed., Cold Spring Harbor Publish., Cold Spring Harbor, NY (2001); Ausubel et al., Current Protocols in Molecular Biology, 4th ed., John Wiley and Sons, New York (1999); which are incorporated by reference herein.) The details of library construction, manipulation and maintenance are also known in the art. (See, e.g., Ausubel et al., supra; Sambrook et al., supra.)

In some aspects, the library is made of synthetic nucleic acid fragments. For example, a population of synthetic oligonucleotides representing all possible sequences of length N (where N is a positive integer), or a subset of all possible sequences, can be the nucleic acids for the library. A population of synthetic oligonucleotides encoding all possible amino acid sequences of length N, or a subset of all possible sequences, can also be the nucleic acids for the library. Alternatively, a semi-random library can be used. For example, a semi-random library can be designed according to the codon usage preference of the host cell or to minimize the inclusion of translational stop codons in the encoded amino acid sequence. As an example of the latter, in the first position of each codon, equimolar amounts of C, A, and G and a one half-molar amount of T would be used. In the second position, A is used at a one half-molar amount while C, T, and G would be used in equimolar amounts. In the third position, only equimolar amounts of G and C would be used.

Synthetic oligonucleotides can optionally include any suitable cis regulatory sequence, such as, for example, a promoter, a translational start codon, a translational termination signal, a transcriptional termination signal, a polyadenylation signal, a cloning site (e.g., a restriction enzyme sites or cohesive end(s)), a sequence encoding an epitope, and/or a priming segment. For example, a library can include DNA fragments having a restriction enzyme site near one end, operably associated with an ATG start codon, a random or semi-random sequence of N nucleotides, a translational stop codon, a primer binding site and a restriction enzyme site at the other end. Such a collection of fragments can be directly ligated into an expression construct, into a vector, into an expression vector, and the like. The fragments can be introduced as single stranded or double stranded DNA, and as either sense or antisense strands. As will be appreciated by the skilled artisan, double stranded nucleic acids can be formed, for example, by annealing complementary single stranded nucleic acids together or by annealing a complementary primer to the nucleic acid and then adding polymerase and nucleotides (e.g., deoxyribonucleotide or ribonucleotide triphosphates) to form double stranded nucleic acids. Double stranded nucleic acids can also be formed by ligating single stranded nucleic acids (e.g., DNA) into a site with 5′ and 3′ overhanging ends and then filling in the partially single stranded nucleic acids with a polymerase and nucleotide triphosphates. The details of manipulating and cloning oligonucleotides are known in the art. (See, e.g., Ausubel et al., supra; Sambrook et al., supra.)

The libraries most typically comprise nucleic acids that have coverage that exceeds the possible permutations of the nucleic acid of the library sequences. For example, a library can comprise a number of nucleic acids that exceeds the possible permutations of nucleic acid sequences by about 5 times, although greater and lesser amounts of redundancy are within the scope of the invention. The details of library construction, manipulation and maintenance are known in the art. (See, e.g., Ausubel et al., supra; Sambrook et al., supra.)

In an exemplary embodiment, a library is created according to the following procedure using methods that are well known in the art. Double stranded DNA fragments are prepared from random or semi-random synthetic oligonucleotides, randomly cleaved genomic DNA and/or randomly cleaved cDNA. These fragments are treated with enzymes, as necessary, to repair their ends and/or to form ends that are compatible with a cloning site in an expression vector. The DNA fragments are then ligated into the cloning site of copies of the expression vector to form an expression library. The expression library is introduced into a suitable host strain, such as an E. coli strain, and clones are selected. The number of individual clones is typically sufficient to achieve reasonable coverage of the possible permutations of the starting material. The clones are combined and grown in mass culture, or in pools, for isolation of the resident vectors and their inserts. This process allows large quantities of the expression library to be obtained in preparation for subsequent procedures described herein.

Expression Cassettes and Vectors

In another aspect, expression cassettes and/or vectors are used to express peptides and/or fusion proteins encoded by sequences of an expression library. There are numerous expression cassettes and vectors known in the art which are readily available for use. (See, e.g., Ausubel et al., supra; Sambrook et al., supra.) Some of these cassettes and vectors are tailored for use in specific cell types, while others can be used in a wide variety of cell types. In mammalian cells, viral transcriptional regulatory elements are a typical choice for driving expression of exogenous coding sequences, such as library sequences. An expression cassette or vector can also include one or more selectable markers to identify host cells that contain the expression vector and/or the expression library.

To effect expression of peptides, an expression cassette can include, for example, in a 5′ to 3′ direction relative to the direction of transcription, a promoter region operably associated with a cloning site for insertion of library sequence and a transcriptional termination region, optionally having a polyadenylation (poly A) sequence.

The expression cassette can optionally include a ribosome binding sequence, a translation initiation codon, and/or a translational termination codon. A secretion signal and/or a domain for anchoring the expressed peptide to the cell surface are typically included adjacent the cloning site.

Suitable secretion signals include, for example, those from CD24. Suitable cell surface-anchoring domains include, for example, a signal for glycophosphatidylinositol (GPI) anchorage or a transmembrane domain (e.g., the transmembrane domain of CD24, IL-3 receptor, and the like).

To effect expression of the library sequences in host cells of a particular type, a promoter capable of conferring robust, high or moderately high expression of the library insert is preferred. Suitable promoter sequences can include, for example, enhancer and/or a TATA box sequences capable of binding an RNA polymerase (such as RNA polymerase II). The promoter can be constitutively active (such as a viral promoters), or it can be inducible. An inducible promoter can be used when controlled expression of library sequences is desired and/or to avoid toxic side affects associated with expression or over-expression of peptide sequences and/or fusion proteins. Suitable inducible promoters include, but are not limited to, interferon inducible promoter systems, the promoters for 3′-5′ poly (A) synthetase or Mx protein (see, e.g., Schumacher et al., Virology 203:144-148, 1994), the HLV-LTR, the metallothionen promoter (see, e.g., Haslinger et al., Proc. Natl. Acad. Sci. USA 82:8572-8576, 1985), the SV40 early promoter region (Bernoist and Chambon, Nature 290:304-310, 1981), the promoter contained in the 3′ long terminal repeat of Rous sarcoma virus (Yamamoto et al., Cell 22:787-797, 1980), the herpes thymidine kinase promoter (Wagner et al., Proc. Natl. Acad. Sci. USA 78:1441-1445, 1981), and the like.

Other suitable promoters can be derived from housekeeping genes that are expressed at high or reasonably high levels. For example, the promoter for β-actin is useful for high expression. (See, e.g., Qin et al., J. Exp. Med 178:355-360, 1993.) Similarly, the cytomegalovirus promoter and the translational elongation factor EF-1α promoter are other strong promoters useful for expression. In general, suitable promoters, such as housekeeping or viral gene promoters, can be identified using well known molecular genetic methods.

In certain embodiments, the cloning site is adjacent to one or more translational termination sequences, such that the length of any resulting expressed peptide is substantially the same as the coding region of the library sequence. As used herein, the phrase “substantially the same length” means that the length of the expressed peptide corresponds to the length of the coding region in the library sequence and can further encode, for example, a methionine residue corresponding to the start codon, any additional amino acids resulting from linker nucleic acids within the coding region, translational or post-translational modifications, one or more epitopes, and the like.

In some embodiments, the cloning site is flanked by a marker epitope. Suitable marker epitopes can include, for example, Xpress™ leader peptide (Asp-Leu-Tyr-Asp-Asp-Asp-Asp-Lys, SEQ ID NO:1; InVitrogen), a myc epitope (Glu-Gln-Lys-Leu-Ile-Ser-Glu-Glu-Asp-Leu-Asn, SEQ ID NO:2; InVitrogen), the V5 epitope (Gly-Lys-Pro-Ile-Pro-Asn-Pro-Leu-Leu-Gly-Leu-Asp-Ser-Thr; SEQ ID NO:3), the FLAG tag (Asp-Tyr-Lys-Asp-Asp-Asp-Asp-Lys, SEQ ID NO:4, (see, e.g., Hopp et al., Biotechnology 6:1205-1210, 1988), the lexA protein, thioredoxin, FLAG, polyhistidine, and the like.

In an exemplary embodiment, to lend additional structure to the expressed peptide sequences, the cloning site can be flanked by sequences encoding cysteines such that the expressed peptide will include cysteine residues at the termini.

In certain embodiments, a cloning site is associated with the coding region of a fusion protein for extracellular display of the peptides (also referred to as a “presentation molecule”). Such a fusion protein can include, for example, (1) homologous protein domains, protein fragments, or proteins as found in the host cell or on the host cell surface, and/or (2) heterologous protein domains, protein fragments, or proteins from another type of cell. The choice of fusion protein depends on the type of host cell(s), the stability of the fusion protein, the desired conformation of the expressed peptide (e.g., constrained or unconstrained). The presentation molecule typically includes a signal sequence and a transmembrane domain.

The presentation molecule can display the peptide at or near the N-terminus, at or near the C-terminus, or internally to the presentation molecule. In an exemplary embodiment, the presentation molecule displays the peptide at the N-terminus and the C-terminal portion of the presentation molecule is anchored to the cell membrane by a transmembrane domain or GPI anchor. The presentation molecule can be modified to position the peptides at varying distances from the host cell surface to increase the probability of achieving the appropriate steric orientation for specific binding between peptides and APP. In addition, spacers (e.g., glycine spacers) can be included between the presentation molecule and the peptide to impart flexibility and minimize steric hindrance from the presentation molecule with peptide interactions in the extracellular space or in the secretory pathway, including interactions of the peptide with APP or APP processing enzymes. Such spacers can also be included between the presentation molecule and the cell surface-anchoring domain to impart flexibility at the cell surface.

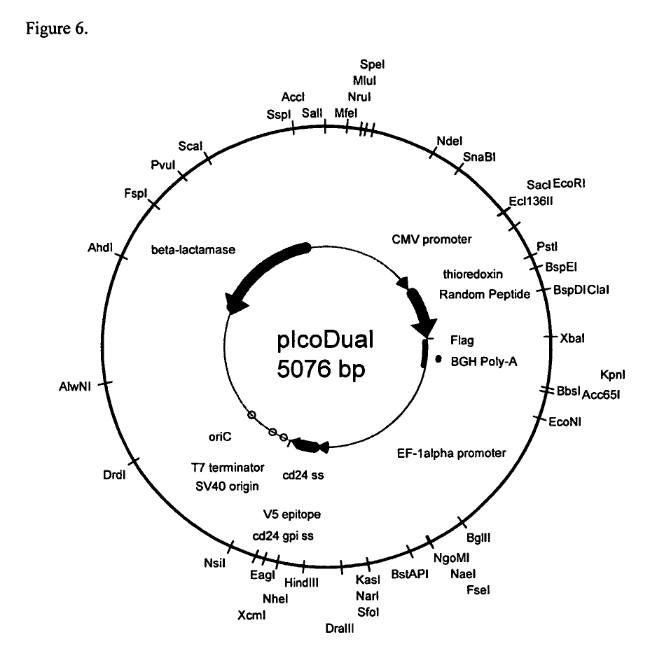

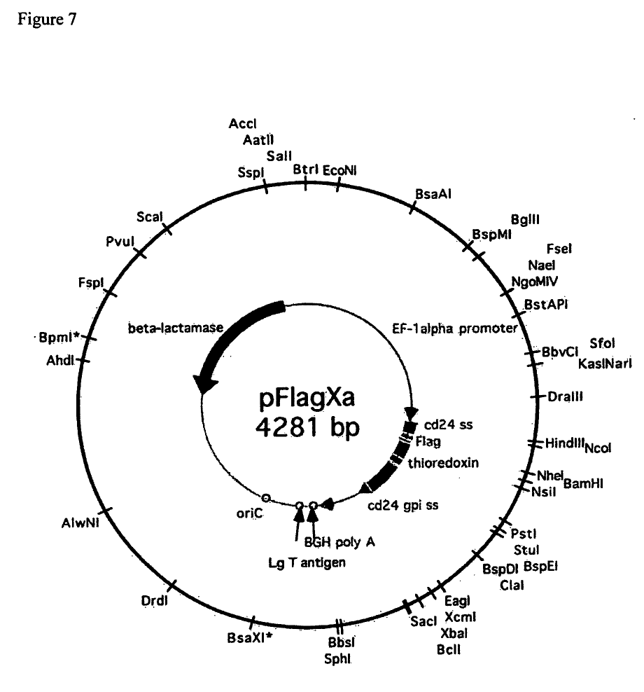

Suitable presentation molecules can include, for example, lymphocyte antigen CD20, modified IL-3 receptor, CD24 (see, e.g., Poncet et al., Acta Neuropathol. (Berl) 91:400-408, 1996), protein A, and the like. Referring to FIG. 6, the pIcoDual vector includes exemplary expression cassettes. For example, one expression cassette encodes a CD24-V5 fusion protein and includes one or more unique restriction sites for insertion of library sequences. Another suitable fusion protein includes E. coli thioredoxin and the FLAG epitope. At the junction between the thioredoxin and FLAG coding sequences, a unique XbaI restriction site permits insertion of library sequences into the fusion protein coding region.

An expression cassette can optionally be part of an expression vector. Suitable expression vectors are known in the art. (See, e.g., Ausubel et al., supra; Sambrook et al., supra.) In certain embodiments, a controlled plasmid amplification system is used for expression in mammalian cells. Such a system allows controlled plasmid amplification in a variety of cells. Increased plasmid copy number can also lead to increased expression of the encoded peptides. High level expression of the peptides can increase the numbers of peptides displayed on an extracellular surface. Such a controlled amplification system also allows for sustained transient expression in mammalian cells. Sustained transient expression can be advantageous because typically 10 times as many cells exhibit transient expression as compared to stable transfection which can allow larger numbers of peptides to be effectively screened. Plasmid amplification also facilitates recovery of plasmids or sequences encoding peptides of interest.

In an exemplary embodiment, the controlled plasmid amplification system utilizes the SV40 replication system. The expression vector contains a fusion of the early promoter of SV40 and the coding region for Large T antigen, so that transcription of Large T antigen is under the control of the early promoter of SV40. The vector also contains the SV40 origin of replication. When this vector enters a cell, the SV40 early promoter promotes transcription of Large T antigen RNA. The RNA is translated into Large T antigen. Large T antigen binds to the SV40 origin and cause amplification of the plasmid. As Large T antigen concentrations rise in the cell, the binding of Large T antigen to the SV40 early promoter shuts down the SV40 early promoter and, consequently, Large T antigen RNA synthesis. The system, therefore, is self-regulating. As the plasmid copy number rises, there will not be an increase in production of Large T antigen that would continue to escalate plasmid amplification to the point of cell death. The amount of Large T antigen in a cell will be a function of the amount of Large T antigen RNA, the stability of the Large T antigen RNA, the stability of Large T antigen protein, the relative affinity for the origin of replication and the SV40 early promoter, and the reduction in the amounts of vector, Large T antigen RNA, and Large T antigen due to cell division. Because the amplification system is contained on a vector, plasmid amplification is typically not limited to the use of COS7 host cells, but rather plasmid amplification can be used for most mammalian cell types.

For other replication systems, the expression vector, if it is of viral origin, may not require propagation in a bacterial host. More typically, however, the vector is propagated in a bacterial host and contains sequences necessary for replication and selection in E. coli, such as, for example, a colE1 replicon and an antibiotic resistance gene.

An expression vector can optionally contain one or more selectable markers. For example, suitable selectable markers for transfection of eukaryotic cells include the genes for hygromycin resistance, neomycin resistance, blasticidin resistance, zeocin resistance, doxorubicin resistance, and the like. Suitable selectable markers for other cells include other antibiotic resistance genes and those complementing auxotrophies (e.g., amino acid auxotrophies). The expression vector can also optionally include a selectable marker to signal that the host cell contains the expression vector. Suitable selectable markers will include green fluorescent protein, or a marker epitope, such as, for example, polyhistidine, the Xpress™ leader peptide (Asp-Leu-Tyr-Asp-Asp-Asp-Asp-Lys, SEQ ID NO:1; InVitrogen), a myc epitope (Glu-Gln-Lys-Leu-Ile-Ser-Glu-Glu-Asp-Leu-Asn, SEQ ID NO:2; InVitrogen, the V5 epitope (Gly-Lys-Pro-Ile-Pro-Asn-Pro-Leu-Leu-Gly-Leu-Asp-Ser-Thr; SEQ ID NO:3), the FLAG tag (Asp-Tyr-Lys-Asp-Asp-Asp-Asp-Lys, SEQ ID NO:4, see, e.g., Hopp et al., Biotechnology 6:1205-1210, 1988), the lexA protein, or bacterial thioredoxin. The markers can be detected, for example, by enzyme assay, by fluorescence using a flow sorter or similar device, using antibodies (e.g., a monoclonal or polyclonal antibody), using bead selection, and the like. When the markers are present on the cell surface, they can be used to isolate or to enrich for cells expressing the marker.

Nucleic Acid Transfer

A variety of methods can be used to transfer library sequences into host cells. (See generally Ausubel et al., supra; Sambrook et al., supra.) Some methods give rise primarily to transient expression in host cells (i.e., the expression is gradually lost from the cell population). Other methods can generate cells that stably express the library sequences, though the percentage of stable expressers is typically lower than transient expressers. Such methods include viral and non-viral mechanisms for nucleic acid transfer.

Suitable mammalian cells include, for example, human embryonic kidney (HEK) cells, human neuroblastoma cell lines, K562, COS7, Ba/F3, AC2 (see, e.g., Garland and Kinnaird, Lymphokine Res. 5:S145-S150, 1986), B9, HepG2, MES-SA, MES-SA/Dx5 cells, and the like. Animal host cells can include, but are not limited to, cells isolated from oncogenic tissues and tumors, including melanocyte, colon, prostate, leukocytes, liver, kidney, uterus, and the like. Certain cells and cell lines are commercially available from, for example, the American Type culture Collection.

For viral vectors, the library sequences are typically carried into the host cell as part of the viral package. Depending on the type of virus, the nucleic acid can remain as an extrachromosomal element (e.g., adenoviruses (see, e.g., Amalfitano et al., Proc. Natl. Acad. Sci. USA 93:3352-3356, 1996) or adeno-associated virus) or it can be incorporated into a host chromosome (e.g., retroviruses (Iida et al., J. Virol. 70:6054-6059, 1996)).

For the transfer of non-viral expression vectors, many methods can be used. (See, e.g., Ausubel et al., supra; Sambrook et al., supra.) One method for nucleic acid transfer is calcium phosphate coprecipitation of nucleic acid. This method relies on the ability of nucleic acid to coprecipitate with calcium and phosphate ions into a relatively insoluble calcium phosphate complex, which settles onto the surface of adherent cells on the culture dish bottom. Other methods employ lipophilic cations that bind nucleic acid by charge interactions while forming lipid micelles. These micelles fuse with cell membranes, introducing the nucleic acid into the host cell where it is expressed. Another method of nucleic acid transfer is electroporation, which involves the discharge of voltage from the plates of a capacitor through a buffer containing nucleic and host cells. This process disturbs the cell membrane sufficiently that nucleic acid contained in the buffer is able to penetrate those membranes. Another method involves using cationic polymers, such as DEAE dextran, to mediate nucleic acid entry and expression in cultured cells. Another method employs ballistic delivery of nucleic acid into cells. Finally, microinjection of nucleic acid can be used.

Large numbers of identical vectors (e.g., expression vectors containing library sequences) can be introduced into each animal cell by fusing such cells with spheroplasts of bacteria harboring a multi-copy vector. The fusion is performed in a manner that on the average allows for the fusion of one spheroplast with one animal cell. For example, when a high copy number plasmid, such as a derivative of a pUC plasmid, is used, many identical plasmids are typically introduced into each animal cell. This method circumvents the need for amplification of the vector in animal host cells, and allows for high copy number in the host cells and the resulting high levels of expression of library sequences. This procedure can also provide for longer periods of transient expression without a need to amplify the vectors in animal host cells. High copy numbers of vector also increase the ease with which library sequences can be recovered from animal host cells which exhibit a change in reporter expression.

In some of the methods, multiple nucleic acids which can encode polypeptides which might interact with a target molecule are introduced into individual cells. Methods are known in the art to minimize transfer of multiple fragments. For example, by using “carrier” nucleic acid (e.g., DNA such as salmon or herring sperm DNA, tRNA, and the like), or by reducing the total amount of nucleic acid applied to the host cells, the problem of multiple fragment entry can be reduced. In addition, each recipient cell can receive multiple nucleic acid fragments. Multiple passages of the library through the host cells permit sequences of interest to be separated ultimately from other sequences that can be present initially as false positives.

In a preferred embodiment, retroviral vectors introduce one peptide sequence into each cell. This supplies a robust signal and reduces the dilution effect on a signal from multiple expression vectors in any given cell.

Host Cells Displaying Peptides

In an exemplary embodiment, peptides, encoded by oligonucleotides comprising an expression library, are displayed within the secretory pathways and extracellular surfaces of host cells into which the expression library has been introduced. Host cells transfected with expression library sequences will co-express APP with peptide molecules, passing simultaneously through the secretory pathway with the effector peptide, and being also tethered to the cell surface along with APP. Thus, the expressed peptides will be present with APP molecules during APP processing and, therefore, these peptides will be available to interact with APP, APP processing enzymes, or other macromolecules that are involved in APP processing. Further, during transience through secretory pathways, the library peptides will be expressed under physiological conditions native to APP processing. Similarly, where the extracellular environment of the host cells is maintained under substantially physiological conditions, library peptides on the extracellular surface will also be expressed under conditions that preserve or approximate those native to APP processing in the extracellular environment.

The peptides are typically displayed under substantially physiological conditions on the surface of host cells, such as mammalian cells. Each host cell can express on its surface hundreds and possibly thousands of copies of one or more library peptides, a majority of which are typically available for binding to extracellular APP target molecules. The peptides are typically present on the surface of a cell for a sustained period of time.

In certain embodiments, the host cells expressing the peptide libraries are freshly prepared or live cells. In other embodiments, the peptide library expressing cells can be fixed, such as in para-formaldehyde or other suitable fixative. Such fixed peptide library-expressing cells optionally can be stored at a suitable temperature (e.g., 4° C.) until use. The peptides are typically presented on the surface of the cells for a sustained period of time.

In some embodiments, host cells transfected with an expression library are enriched for cells that contain the expression vector and optimally expressing a library peptide. Such selection is typically based on selectable markers contained within the library expression vector (see Expression Cassettes and Vectors). Methods for selection using selectable markers are known in the art. For example, FACS can be used detect fluorescently labeled antibodies to epitopes encoded by the expression vector (e.g., V5, FLAG, thioredoxin, and the like) or to the presentation molecule itself (e.g., CD24). In addition, magnetic bead selection can be used by known methods.

Prescreening of Agents for Agents That Specifically Bind to APP In certain embodiments, compound libraries and expression libraries can be prescreened to identify agents that specifically bind to APP. Prescreening can be performed, for example, under substantially physiological conditions. Agents identified as specifically binding to APP can be used to generate a compound or expression library enriched for APP-binding agents (“pre-enriched compound library” or “pre-enriched expression library”).

For example, this can be accomplished by expressing the external domain of APP (edAPP) with an affinity tag such as a His tag, binding the edAPP to a column, passing compound libraries over the column, and eluting the enriched compounds. The enriched compounds can then be tested in the cell based assay of the invention.

In addition, in certain embodiments, N-terminal truncated forms of APP are used to prescreen agents for specific binding to APP. These truncated forms have the advantage of being a more specific target for peptide enrichment. The utility of using the shorter forms is underscored by the fact that the a and P cleavage sites are not significantly affected by removal of most of the N-terminal sequence of APP (see DeStooper et al., J. Biol. Chem. 270:30310-30314, 1995; Lammich et al., Proc. Natl. Acad. Sci. USA 96:3922-3927, 1999). The shorter forms can be expressed as N- or C-terminus fusion proteins of, for example, thioredoxin, horse radish peroxidase (HRP), protein A, or other presentation protein. The secreted form of APP₆₉₅ is also available commercially as a soluble recombinant protein (Sigma-Aldrich).

In an exemplary embodiment of the invention, the peptide expression libraries are prescreened to identify oligonucleotides encoding peptides that specifically bind to APP. Those clones identified as encoding APP-binding peptides can be recovered and amplified using methods known in the art to produce a pre-enriched expression library. This pre-enriched expression library comprises a population of oligonucleotide sequences enriched for those that encode peptides that bind to APP. The enriched library of oligonucleotide sequences can then be introduced into host cells according to the methods of the present invention to identify those APP-binding peptides that alter APP processing.

For example, using methods known in the art, the expression library can be introduced into an animal host cell for expression or, alternatively, expressed using a non-animal system such as, e.g., phage display. The expressed peptides can then be contacted with labeled APP and/or N-terminal truncated forms of APP, either soluble forms (e.g., the extracellular domain of APP or the N-terminal truncated form) or expressed on the surface of animal host cells. Suitable labels include, for example, radioactive labels (e.g., ³H, ¹⁴C, ³²p, ³⁵S, ¹²⁵I, ¹³¹I, and the like), fluorescent molecules (e.g., fluoroscein isothiocyanate (FITC), rhodamine, phycoerythrin (PE), phycocyanin, allophycocyanin, orthophthaldehyde, fluorescamine, peridinin-chlorophyll a (PerCP), Cy3 (indocarbocyanine), Cy5 (indodicarbocyanine), lanthanide phosphors, and the like), enzymes (e.g., horseradish peroxidase, β-galactosidase, luciferase, alkaline phosphatase), biotinyl groups, tag epitopes as described above, and the like. In some embodiments, detectable labels are attached by spacer arms of various lengths to reduce potential steric hindrance. Alternatively, labeled binding partners, such as, for example, antibodies that bind to the target molecules can be used. In one exemplary embodiment, the APP molecules are labeled with a His tag epitope label.

The expressed peptides that bind to APP or one of the truncated forms of APP containing various extracellular domains can then be identified using the label and methods known in the art. For example, phage or cells expressing peptides and exposed to His tag extracellular domain APPs can be passed over a His tag affinity column to enrich for those phage or cells expressing APP-binding peptides. Alternatively, for example, peptide-expressing animal cells can be exposed to fluorescently tagged extracellular APP or truncated APP and APP-binding cells can be identified and sorted by FACS to obtain cells expressing the peptides that specifically bind APP. Multiple rounds of such enrichment can be performed.

After enrichment of cells or phage expressing APP-binding peptides, the peptide encoding sequences can be excised from the expression vector used for pre-enrichment and transferred, using known methods, to an appropriate vector (see Expression Cassettes and Vectors, infra) for screening for those APP-binding peptides that alter APP processing. In some embodiments of the invention, where animal host cells are used for pre-enrichment, the expression vector used for the screening of peptides that alter APP processing can be the same as used for peptide expression during pre-screening.

Detection of Agents That Alter APP Processing

In another aspect, the effect of agents within the compound or expression libraries on APP processing is assayed. The host cells expressing APP and at least one APP processing enzyme are contacted with the agents and the host cells are then assayed for an effect on the processing of APP expressed by the host cell. In some embodiments, the host cells are contacted with the agents under substantially physiological conditions. In an exemplary embodiment, the effect on APP processing of peptides comprising a peptide expression library is assayed, the expression library having been introduced into the host cells (see Genetic Libraries, Expression Cassettes and Vectors, Nucleic Acid Transfer, and Host Cells Displaying Peptides, supra). In another embodiment, an extract from, for example, a plant, e.g., a peat extract, comprising an agent of the present invention is admixed with the host cells for a sufficient time period to detect an effect.

Effects of agents within the libraries on APP processing can be detected by any suitable detection means, such as, for example, the use of markers that specifically bind to particular APP fragments such as, for example, APPs-α, APPs-β, or APPs-γ. Using such markers, the relative presence or absence of a particular APP fragment that correlates with Aβ production, in comparison to host cells that have not been contacted with agents or that do not express library peptide sequences, can be determined. For example, APP specific binding markers can be labeled with fluorescent tags and the host cells assessed for the relative presence or absence of such marker by known methods such as, e.g., (FACS) analysis. In an exemplary embodiment, the markers are antibodies specific for particular epitopes of APP or APP fragments. Antibodies to particular APP fragments, including for example, APPs-β (such as for example, A3 or 1G7 specific to APP midregion, Koo et al., J. Biol. Chem. 269:17386-17389, 1994), APPs-α (e.g., 6E10, Pirttila et al., Neurol Sci. 127:90-95, 1994, McLaurin et al., Nature Med 8:1263-1269, 2002, specific for the carboxyl terminal end of APPs-α or the region of APP between the β and α cleavage sites), and p3 (e.g., 4G8, Pirttila et al., Neurol Sci. 127:90-95, 1994, McLaurin et al., Nature Med. 8:1263-1269, 2002).

In an exemplary embodiment, where the host cells express more than one APP processing enzyme, the ratio of detection signals of at least two labeled markers specific for at least two different APP fragments can be determined. Altered APP processing can then be determined by detecting a change in this ratio in host cells expressing library sequences. For example, in host cells expressing both a- and β-secretase, antibodies specific for APPs-α and APPs-β can be labeled with two different fluorescent tags (e.g., FITC and PE) and the presence of bound, labeled antibody determined by FACS. Host cells expressing library peptides can then be selected according to an increase in APPs-β:APPs-α signal ratio, indicating a reduction in the β-secretase processing.

In some embodiments, agents identified as having an effect on APP processing can be used to build a sub-library enriched for agents that affect APP processing. This sub-library can then be contacted with host cells in subsequent rounds of screening to identify agents with the desired characteristics (see Characterization of Library Constituents, infra).

In an exemplary embodiment, host cells expressing a peptide library that are isolated or collected by any of the methods described herein can be used to re-isolate the genetic library sequences(s) so as to build a sub-library of sequences enriched for those that affect APP processing. As will be appreciated by those skilled in the art, such sequences can be isolated by, among other methods, recovering expression vector nucleic acids from the selected clones and transforming them into a suitable bacterial host strain, by cloning the library oligonucleotides by PCR using any suitable priming site(s) that flanks the oligonucleotide inserts, by subcloning the oligonucleotides from the original expression vector into another vector, and the like. The sub-library of oligonucleotides optionally can be recloned into an expression cassette or vector, as necessary, and reintroduced into the host cells for subsequent rounds of screening. Screening/selection cycles can be repeated as many times as necessary.

In certain embodiments, after a sufficient number of cycles, a substantial difference is observed in the assay signals or ratios thereof, indicating changes in the presence of fragments of APP between an enriched sub-library of peptide sequences and the original peptide library (e.g., in an intensity distribution). By the process of sequential introduction of the expression library, or portions thereof, sorting in a flow sorter or similar device and isolation of nucleic acids from host cells exhibiting the desired assay results, a population of library oligonucleotides can be identified that encode the desired peptide(s). The oligonucleotides can then be isolated and studied individually by molecular cloning and nucleic acid sequence analysis. If a sufficient number of cycles have been carried out, many, and typically most, separate oligonucleotides should encode a peptide that produces about the same effect binding event when expressed on host cells.

Identification of Allosteric Effectors

In certain embodiments, effector agents can be assayed to identify allosteric effectors of APP. Identification of allosteric effectors can be performed as a secondary screen on agents that have been identified as effectors of APP processing. Alternatively, compound libraries or peptide expression libraries can be prescreened to identify agents that bind to a potential allosteric site on APP. The identification of allosteric effectors can be done directly using the cell based assay followed by identifying those agents that bind to APP and measuring any change in the structure of APP by known methods. In the method comprising a prescreening step, the system is predisposed to the identification of APP allosteric effectors.

Characterization of Library Constituents

Effector agents identified using any of the procedures described herein can be further characterized. Where expression libraries are used to display peptides within secretory pathways and on the extracellular surface of host cells, library sequences can be isolated from host cells by any suitable method, such as, for example, HIRT lysis and recovery of vectors in bacterial host cells, polymerase chain reaction, and the like. (See, e.g., Hirt, J. Mol. Biol. 26:365-369, 1967; U.S. Pat. Nos. 4,683,202, 4,683,195 and 4,800,159; Innis et al., PCR Protocols: A Guide to Methods and Applications, Academic Press, Inc., San Diego, Calif. (1989); Innis et al., PCR Applications: Protocols for Functional Genomics, Academic Press, Inc., San Diego, Calif. (1999); White (ed.), PCR Cloning Protocols: From Molecular Cloning to Genetic Engineering, Humana Press, (1996); EP 320 308; Ausubel et al., supra; Sambrook et al., supra; which are incorporated by reference herein in their entirety.)

Subsequent rounds of screening optionally can be performed to enrich for agents that alter APP processing. Sub-libraries of compound or expression libraries can be passed through additional screens and/or selections to enrich for those agents or oligonucleotide sequences that have more desirable properties. To enrich for effector agents that have more favored properties, it can be desirable to passage a sub-library (that has been isolated by any of the methods described above) through additional screens to enrich for those agents with, for example, improved specificity or avidity for APP or with an increased effect on APP processing. For instance, minor effects on an undesirable secretory or extracellular interaction can be eliminated by appropriate secondary screens. If desired, additional labels can be used to identify library peptide sequences that affect secretory or extracellular molecular interactions. In addition, effector agents that have generalized, non-specific effects on secretory or extracellular interactions can be identified by contacting compound sub-libraries or individual effector agents with (or passing expression sub-libraries or individual library peptide sequences through) different host cells that lack APP or APP processing enzyme expression and then conducting screens on those cells that assay for processing alterations or other effects on other, non-APP secretory or cell-surface molecules.

In some cases, effector agents identified according to the present invention can be used to identify other agents that alter APP processing. For example, small organic molecules identified as molecular effectors of APP processing can used in directed-screening approaches to identify agents with improved characteristics, including, e.g., reduced toxicity or increased efficacy. For example, modifications can be made to one or more subunits comprising the effector agent. Modifications can include variation as to type, number, or position of R groups. Modified small molecule effector agents can then be screened using the methods described herein for agents with the improved characteristics.

Further, where peptide libraries are used, including peptide expression libraries, peptide or oligonucleotide sequences can be modified. In some cases, an original library may not contain all possible permutations of an amino acid sequence of length N (e.g., when the original library is a semi-random library). In such cases, it can be possible to isolate and use the identified peptides as a starting material (“lead compound”) to identify additional peptides or peptides with enhanced function (e.g., higher avidity or affinity) as compared with the original peptide. To isolate variants of a library sequences, amplification of nucleic acids (e.g. by polymerase chain reaction) can be used to introduce sequence changes during the replication process. (See, e.g., Cline et al., Nucleic Acids Res. 24:3546-3551, 1996). Such mutations can lead to sequence variants that have more effective properties. Alternatively, it can be desirable to seek improved variants of existing sequences by deliberately subjecting the amplification process to conditions that enhance mutation and/or recombination of the nucleic acid(s), such as by, for example, in vitro mutagenesis, error-prone PCR and/or recombinational PCR. (See, e.g., Ausubel et al., supra; Stemmer, Nature 370:389-391, 1994). Such conditions are known in the art and provide a means for searching for sequences that are active at lower concentrations and/or that demonstrate increased specificity and/or activity compared to the sequences expressed by the original library.

Applications of the Molecular Effectors of APP Processing

The methods according to the present invention provide the ability to identify physiologically relevant effector agents that bind and alter the processing of APP, particularly under physiological conditions.

Effector agents identified using the methods described herein can be tested, for example, in vivo in an animal model. Identified agents can be, e.g., those effector molecules (“EM”) identified as stimulating APP processing by α-secretase (“EMα”) or inhibiting APP processing by β-secretase (“EMβ”). In a preferred embodiment, the animal is one that exhibits pathological conditions typically associated with Alzheimer's disease, particularly increased levels of Aβ. For example, the animal can be a transgenic mouse having a pathogenic mutation associated Alzheimer's disease such as, e.g., Tg(HuAPP695.K670N/M671L) (Hasio et al., Science 274:99-102, 1996) or the PDAPP (V171F) (Games et al., Nature 373:523-527, 1995).

In certain embodiments, the identified agent can be administered directly to the animal by, e.g., direct injection or oral administration. In addition, where the effector agent is a peptide, the identified peptide can be also be tested by expressing the peptide in the animal model. For example, in one embodiment, a construct encoding the peptide can be introduced into an animal by, e.g., direct injection into a specific target tissue (e.g., CSF, or brain). In another embodiment, the construct encoding the effector peptide is a transgene expressed in a transgenic mouse model. Transgenic mice expressing effector peptide transgenes can also be crossed with, for example, transgenic mice having pathogenic Alzheimer's disease mutations (e.g., transgenic mice having APP genes with the Swedish and/or Arctic mutations). The identified effector peptides can be expressed and presented extracellularly as a membrane-bound presentation molecule or expressed and secreted into the extracellular space without a membrane anchor. Further, expression of the effector peptide can be targeted to a specific tissue using, for example, a tissue-specific promoter (e.g., the Thy1 promoter for expression in neural tissue).

Once the agent is introduced into the animal, the animal is monitored for an effect on a physiological condition or symptom associated with altered APP processing such as, for example, a capacity to reduce AD levels in CSF, brain cells, and/or serum; plaque inhibition; or a decrease in other pathological conditions or indications associated with Alzheimer's disease.

Additional Modifications to Enhance Function of Peptide Effectors

As discussed previously, peptide sequences that affect differential processing of APP can exert their effect in a variety of ways. As will be appreciated by those skilled in the art, it can be possible to improve the effectiveness of a peptide by synthesizing peptide variants or analogs. For example, the effectiveness of peptides might be improved by administering the peptides themselves (i.e., without any extra sequences).

One skilled in the art will appreciate that structural analogs and derivatives of peptides (e.g., peptides having conservative amino acid insertions, deletions or substitutions, peptidomimetics, disulphide cross-linking, artificial cross-linking, or the like) can also be useful as therapeutic agents. For example, in addition to the above-described peptides, which can comprise naturally-occurring amino acids, peptide analogs can be used as non-peptide drugs with properties analogous to those of the template peptide. These types of non-peptide compounds can be developed, for example, with the aid of computerized molecular modeling. (See, e.g., Fauchere, Adv. Drug Res. 15:29, 1986; Veber and Freidinger, TINS 392, 1985; Evans et al., J. Med Chem. 30:1229, 1987). Such analogs, or a peptide mimetic, are structurally similar to a therapeutically or prophylactically useful peptide and can be used to produce an equivalent therapeutic or prophylactic effect. In some cases, a peptide mimetic can have significant advantages over peptides, including, for example, more economical production, greater chemical stability, enhanced pharmacological properties (e.g., half-life, absorption, potency, efficacy, and the like), altered specificity (e.g., a broad-spectrum of biological activities), increased, reduced antigenicity, increased passage over the blood brain barrier, and other desired properties.

Peptide mimetics can be generated by methods known in the art and further described in the following references: Spatola, Chemistry and Biochemistry of Amino Acids, Peptides, and Proteins (Weinstein, ed.) 267, 1983; Spatola, Vega Data, Vol. 1, Issue 3, “Peptide Backbone Modifications” (March 1983); Morley, Trends Pharm Sci., pp. 463-468, 1980; Hudson et al., Int. J. Pept. Prot. Res. 14:177-185, 1979; Spatola et al., Life Sci. 38:1243-1249, 1986; Hann, J. Chem. Soc. Perkin Trans. I, pp. 307-314, 1982; Ainquist et al., J. Med Chem. 23: 1392-1398, 1980; Jennings-White et al, Tetrahedron Lett. 23:2533, 1982; European Patent Application EP 45665, 1982; Chemical Abstract 97:39405, 1982; Holladay et al., Tetrahedron Lett. 24:4401-4404, 1983; and Hruby, Life Sci. 31:189-199, 1982.

In one aspect, pharmaceutically acceptable salts of a peptide (or analog or mimetic) can be readily prepared by conventional methods. For example, such a salt can be prepared by treating the peptide with an aqueous solution of the desired pharmaceutically acceptable metallic hydroxide or other metallic base and then evaporating the resulting solution to dryness, typically under reduced pressure in a nitrogen atmosphere. Alternatively, a solution of a peptide can be mixed with an alkoxide of the desired metal, and the solution subsequently evaporated to dryness. The phannaceutically acceptable hydroxides, bases, and alkoxides encompass those with cations for this purpose, including, but not limited to, potassium, sodium, ammonium, calcium, and magnesium. Other representative pharmaceutically acceptable salts include hydrochloride, hydrobromide, sulfate, bisulfate, acetate, oxalate, valerate, oleate, laurate, borate, benzoate, lactate, phosphate, tosylate, citrate, maleate, fumarate, succinate, tartrate, and the like.

It can be desirable to stabilize the peptides or their analogs or derivatives to increase their shelf-life and pharmacokinetic half-life. Shelf-life stability can be improved by adding excipients such as: a) hydrophobic agents (e.g., glycerol); b) sugars (e.g., sucrose, mannose, sorbitol, rhamnose, or xylose); c) complex carbohydrates (e.g., lactose); and/or d) bacteriostatic agents. The pharmacokinetic half-life of the peptides can be modified by coupling to carrier peptides, polypeptides, and carbohydrates using chemical derivatization (e.g., by coupling side chain or N- or C-terminal residues), or by chemically altering an amino acid of the subject peptide. The pharmacokinetic half-life and pharmacodynamics of these peptides can also be modified by: a) encapsulation (e.g., in liposomes); b) controlling the degree of hydration (e.g., by controlling the extent and type of glycosylation of the peptide); c) controlling the electrostatic charge and hydrophobicity of the peptide, and d) formulation in a pharmaceutically acceptable depots such as polyactic acid, polyglycolic acid, poly lactic-co-glycolic acid, or the like.

For therapeutic administration, agents and mimetics of the invention can be formulated with a pharmaceutically acceptable carrier. As used herein, “pharmaceutically acceptable carrier” includes any and all solvents, dispersion media, coatings, antibacterial and antifungal agents, isotonic and absorption enhancing or delaying agents, and other excipients or additives that are physiologically compatible. In specific embodiments, the carrier is suitable for intravenous, intramuscular, subcutaneous, parenteral, oral, or dermal administration. Depending on the route of administration, the active agent can be coated in a material to protect the agent from the action of acids and other natural conditions which may inactivate the agent.

In preparing pharmaceutical compositions of the present invention, it can be desirable to modify the agent, or combine or conjugate the agent or mimetic compound with other agents, to alter pharmacokinetics and biodistribution of the selected agent. A number of methods for altering pharmacokinetics and biodistribution are known to persons of ordinary skill in the art. Examples of such methods include protection of various agents, peptides, or complexes thereof in vesicles composed of other proteins, lipids, carbohydrates, or synthetic polymers. For example, agents of the invention can be incorporated into liposomes in order to enhance pharmacokinetics and biodistribution characteristics. A variety of methods are available for preparing liposomes, as described in, e.g., Szoka et al. (Ann. Rev. Biophys. Bioeng. 9:467, 1980; U.S. Pat. Nos. 4,235,871; 4,501,728 and 4,837,028, each incorporated herein by reference). For use with liposome delivery, the agent is typically entrapped within the liposome, or lipid vesicle, or is bound to the outside of the vesicle. Several strategies have been devised to increase the effectiveness of liposome-mediated delivery by targeting liposomes to specific tissues and specific cell types. Liposome formulations, including those containing a cationic lipid, have been shown to be safe and well tolerated in human patients (Treat et al., J. Natl. Cancer Instit. 82:1706-1710, 1990).

The compositions of the invention can alternatively contain as pharmaceutically acceptable carriers, substances as required to approximate physiological conditions, such as pH adjusting and buffering agents, tonicity adjusting agents, wetting agents and the like, for example, sodium acetate, sodium lactate, sodium chloride, potassium chloride, calcium chloride, sorbitan monolaurate, triethanolamine oleate, etc.

For solid compositions, conventional nontoxic pharmaceutically acceptable carriers can be used which include, for example, pharmaceutical grades of mannitol, lactose, starch, magnesium stearate, sodium saccharin, talcum, cellulose, glucose, sucrose, magnesium carbonate, and the like. For oral administration, a pharmaceutically acceptable nontoxic composition is formed by incorporating any of the normally employed excipients, such as those carriers previously listed, and generally about 10-95%, more typically about 25% -75% of active ingredient.

Therapeutic compositions for administering the agent can also be formulated as a solution, microemulsion, or other ordered structure suitable for high concentration of active ingredients. The carrier can be a solvent or dispersion medium containing, for example, water, ethanol, polyol (for example, glycerol, propylene glycol, and liquid polyethylene glycol, and the like), and suitable mixtures thereof. Proper fluidity for solutions can be maintained, for example, by the use of a coating such as lecithin, by the maintenance of a desired particle size in the case of dispersible formulations, and by the use of surfactants. In many cases, it will be desirable to include isotonic agents, for example, sugars, polyalcohols such as mannitol, sorbitol, or sodium chloride in the composition. Prolonged absorption of the injectable compositions can be brought about by including in the composition an agent which delays absorption, for example, monostearate salts and gelatin.

In certain embodiments of the invention, the agent is administered in a time release formulation, for example in a composition which includes a slow release polymer, or by depot injection. The active agent or mimetic can be prepared with carriers that will protect against rapid release, for example a controlled release vehicle such as implants, transdermal patches, or microencapsulated delivery system. Prolonged delivery of the agent, or a biologically active analog or mimetic thereof, in various compositions of the invention can be brought about by including in the composition agents that delay absorption, for example, aluminum monosterate hydrogels and gelatin. When controlled release formulations of the agent is desired, controlled release binders suitable for use in accordance with the invention include any biocompatible controlled-release material which is inert to the active ingredient and which is capable of incorporating the selected agent. Numerous such materials are known in the art. Useful controlled-release binders are materials which are metabolized slowly under physiological conditions following their subcutaneous or intramuscular injection in mammals (i.e., in the presence of bodily fluids which exist there). Appropriate binders include but are not limited to biocompatible polymers and copolymers previously used in the art in sustained release formulations. Such biocompatible compounds are non-toxic and inert to surrounding tissues, e.g., following subcutaneous or intramuscular injection, and do not trigger significant adverse effects such as immune response, inflammation, or the like. They are metabolized into metabolic products which are also biocompatible and easily eliminated from the body.

For example, a polymeric matrix derived from copolymeric and homopolymeric polyesters having hydrolysable ester linkages may be used. A number of these are known in the art to be biodegradable and to lead to degradation products having no or low toxicity. Exemplary polymers include polyglycolic acids (PGA) and polylactic acids (PLA), poly(DL-lactic acid-co-glycolic acid)(DL PLGA), poly(D-lactic acid-coglycolic acid)(D PLGA) and poly(L-lactic acid-co-glycolic acid)(L PLGA). Other useful biodegradable or bioerodable polymers include but are not limited to such polymers as poly(epsilon-caprolactone), poly(epsilon-aprolactone-CO-lactic acid), poly(epsilon.-aprolactone-CO-glycolic acid), poly(beta-hydroxy butyric acid), poly(alkyl-2-cyanoacrilate), hydrogels such as poly(hydroxyethyl methacrylate), polyamides, poly(amino acids) (i.e., L-leucine, glutamic acid, L-aspartic acid and the like), poly (ester urea), poly (2-hydroxyethyl DL-aspartamide), polyacetal polymers, polyorthoesters, polycarbonate, polymaleamides, polysaccharides and copolymers thereof. Many methods for preparing such formulations are generally known to those skilled in the art (see, e.g., Sustained and Controlled Release Drug Delivery Systems, J. R. Robinson, ed., Marcel Dekker, Inc., New York, 1978). Useful formulations include controlled-release compositions such as, e.g., microcapsules (U.S. Pat. Nos. 4,652,441 and 4,917,893, each incorporated herein by reference), injectable formulations (U.S. Pat. No. 4,849,228, incorporated herein by reference), lactic acid-glycolic acid copolymers useful in making microcapsules or injectable formulations (U.S. Pat. Nos. 4,677,191 and 4,728,721, each incorporated herein by reference), and sustained-release compositions for water-soluble peptides (U.S. Pat. No. 4,675,189, incorporated herein by reference). A long-term sustained release implant also can be used. These can be readily constructed to deliver therapeutic levels of the selected agent for at least 10-20 days, often at least 30 days, up to 60 days or longer. Long-term sustained release implants are well known to those of ordinary skill in the art and can incorporate some of the absorption delaying components described above. Such implants can be particularly useful by placing the implant near or directly within the target tissue or cell population, thereby affecting localized, high-doses of the agent at one or more sites of interest.

The selected agent of the invention can be enclosed in a hard or soft shell gelatin capsule, compressed into tablets, or incorporated directly into a subject's diet. For oral therapeutic administration, the agent can be incorporated with excipients and used in the form of ingestable tablets, buccal tablets, troches, capsules, elixirs, suspensions, syrups, wafers, and the like. Of course, taste-irnproving substances can be added in the case of oral administration forms. The percentage (e.g., by weight or by volume) of the selected agent in these compositions and preparations can, of course, be varied. As noted above, the amount of the selected agent in a therapeutically useful composition is generally such that a therapeutically effective dosage will be delivered.

For oral administration, the selected agent can be worked into tablets or other solid forms by being mixed with solid carrier substances, such as sodium citrate, calcium carbonate or dicalcium phosphate, and binders such as polyvinyl pyrrolidone, gelatin or cellulose derivatives, possibly by adding also lubricants such as magnesium stearate, sodium lauryl sulfate, “Carbowax” or polyethylene glycol. Solid delivery vehicles can contain the agent of interest, e.g., a peptide, in mixture with fillers, such as lactose, saccharose, mannitol, starches, such as potato starch or amylopectin, cellulose derivatives or highly dispersed silicic acids. In soft-gelatin capsules, the active substance is dissolved or suspended in suitable liquids, such as vegetable oils or liquid polyethylene glycols. As further forms, one can use plug capsules, e.g., of hard gelatin, as well as dosed soft-gelatin capsules comprising a softener or plasticizer, e.g., glycerin.

Alternatively, liquid dosage forms for delivering the selected agent can include solutions or suspensions in water, pharmaceutically acceptable fats and oils, alcohols or other organic solvents, including esters, emulsions, syrups or elixirs, suspensions, solutions and/or suspensions reconstituted from non-effervescent granules and effervescent preparations reconstituted from effervescent granules. Such liquid dosage forms can contain, for example, suitable solvents, preservatives, emulsifying agents, suspending agents, diluents, sweeteners, thickeners, and melting agents. Oral dosage forms optionally contain flavorants and coloring agents. Parenteral and intravenous forms would also include minerals and other materials to make them compatible with the type of delivery system chosen.

The therapeutic compositions of the invention typically must be sterile and stable under all conditions of manufacture, storage and use. Sterile injectable solutions can be prepared by incorporating the selected agent in the required amount in an appropriate solvent with one or a combination of ingredients enumerated above, as required, followed by filtered sterilization. Generally, dispersions are prepared by incorporating the agent into a sterile vehicle which contains a basic dispersion medium and the required other ingredients from those enumerated above. In the case of sterile powders for the preparation of sterile injectable solutions, methods of preparation include vacuum drying and freeze-drying which yields a powder of the active ingredient plus any additional desired ingredient from a previously sterile-filtered solution thereof. The prevention of the action of microorganisms can be accomplished by various antibacterial and antifungal agents, for example, parabens, chlorobutanol, phenol, sorbic acid, thimerosal, and the like.

In more detailed aspects of the invention, the selected agent is stabilized to extend its effective half-life following delivery to the subject, particularly for extending metabolic persistence in an active state within the physiological environment (e.g., in the bloodstream, cerebral spinal fluid, or within a connective tissue compartment or fluid-filled body cavity). For this purpose, the selected binding agent may be modified by chemical means, e.g., chemical conjugation, N-terminal capping, PEGylation, or recombinant means, e.g., site-directed mutagenesis or construction of fusion proteins, or formulated with various stabilizing agents or carriers. Thus stabilized, the selected agent administered as above retains activity for an extended period (e.g., 2-3, up to 5-10 fold greater stability) under physiological conditions compared to its non-stabilized form. For example, agents of the invention can be modified to enhance circulating half-life by shielding the agent, particularly if the agent is a peptide or analog thereof, by conjugation to other known protecting or stabilizing compounds, or by the creation of fusion proteins with the peptide or analog linked to one or more carrier proteins, such as one or more immunoglobulin chains (see, e.g., U.S. Pat. Nos. 5,750,375; 5,843,725; 5,567,584 and 6,018,026, each incorporated herein by reference). These modifications can decrease the degradation, sequestration or clearance of the agent and result in a longer half-life in a physiological environment (e.g., in the circulatory system, or the cerebral spinal fluid). The agents modified by a stabilizing method are therefore useful with enhanced efficacy within the methods of the invention. In particular, the agents thus modified maintain activity for greater periods at a target site of delivery compared to the unmodified peptide or analog.

The instant invention also includes kits, packages and multicontainer units containing the above described pharmaceutical compositions, active ingredients, and/or means for administering the same for use in the treatment of Alzheimer's disease. Briefly, these kits include a container or formulation which contains an agent, typically formulated in a pharmaceutical preparation with a biologically suitable carrier. The agent is optionally contained in a bulk dispensing container or unit or multi-unit dosage form. Packaging materials optionally include a label or instruction which indicates that the pharmaceutical agent packaged therewith can be used for treating Alzheimer's disease. The kits may also contain suitable buffers, preservatives such as protease inhibitors.

### EXAMPLES

The following examples are provided merely as illustrative of various aspects of the invention and should not be construed to limit the invention in any way.

### Example 1

### Preparation of a Genetic Library in a Host Cell

A genetic library is prepared by inserting random oligonucleotides into a cloning site of an expression vector. The expression vector has an expression cassette comprising, in a 5′ direction relative to the direction of transcription, a promoter, a nucleic acid encoding a signal sequence, a nucleic acid encoding a presentation molecule, a cloning site located at the 5′ end of the nucleic acid encoding the presentation molecule, a nucleic acid encoding a transmembrane domain, and a transcription terminator. The expression vector includes an origin of replication (ColE1) and an antibiotic resistance marker for selection in E. coli. The random oligonucleotides encode peptides of about 7 to about 20 amino acid residues. The vectors containing the oligonucleotides are transformed into host bacteria and grown under selectable conditions to establish a library of about 10 million to several billion independent isolates. Vector DNA is prepared from this library. This vector DNA is introduced into animal cells, such as, for example, human cells, mammalian cells, or other animal cells.

### Example 2

### Engineering the Random Peptide Vector for the Expression of APP Effectors

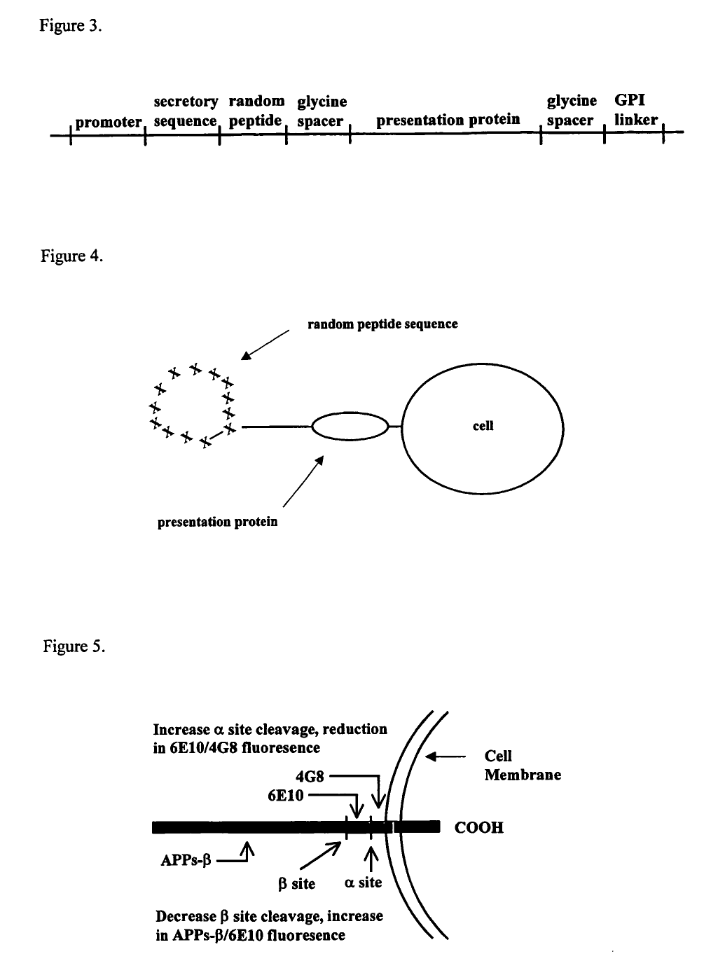

The preferred random peptide vector for the expression of APP effectors is a retroviral vector with the cassette insert shown in the FIG. 3. The cassette encodes a promoter; a secretory sequence to cause the protein to enter the secretory pathway; a random peptide sequence encoding cysteines at the termini of the random sequence to cause disulfide bridge formation lending structure to the random amino acid sequence; a glycine spacer; a presentation protein; a second glycine spacer to impart flexibility at the cell surface; and a GPI linker sequence that causes the fusion protein to be tethered to the cell surface. The presentation protein is a globular inert protein on which the random peptide sequence is tethered and displayed. This configuration allows the peptide ring of random amino acids to be tethered at the end of a string of glycines providing flexibility. The glycine spacer between the cell and the presentation protein also allows for flexibility of the whole tethered molecule. Flexibility for the peptide ring minimizes steric hindrance from the presentation protein with the binding of the random amino acid sequence to APP.

### Example 3

### Expression Vector Construction

To achieve high expression levels of library peptides on the surface of host cells, an expression vector is used. The expression vector includes markers required for propagation and selection in bacteria, an expression cassette including a mammalian cell transcription promoter (e.g., the cytomegalovirus or EF-1α promoter, and the like), a nucleic acid encoding a presentation molecule and a transcription terminator. Random library sequences can be inserted at the N-terminus, at the C-terminus, or internally in the nucleic acid encoding the presentation molecule and can be in a linear or constrained loop array or in an exposed loop of the presentation molecule.

To attach the presentation molecule to the surface of host cells, the nucleic acid encoding the presentation molecule includes a sequence encoding a secretory signal sequence and an element to tether the fusion protein to the cell surface (e.g., a signal for glycophosphatidylinositol (GPI) anchorage or a transmembrane and intracellular domain). Suitable presentation molecules include, for example, the IL-3 receptor, protein A, thioredoxin, CD4, CD20, or CD24. The presentation molecule can also include one or more epitopes, such as, for example, FLAG, V5 or polyhistidine. The transcription terminator, can be, for example, from human growth hormone.

Two distinct expression vectors were constructed to display peptide libraries on the surface of cells of mammalian cells such as COS7 and K562 cells. One construct places the peptides, having about 7 or about 12 amino acid residues, at the N-terminus as a linear structure, while the other construct includes a cysteine residue at each end of the peptide sequences to form a constrained loop at the N-terminus. Each construct encodes a presentation molecule including protein A, thioredoxin, the V5 or FLAG epitopes, the secretory signal sequence from CD24 for secretion, and the GPI linkage sequence from CD24 for attachment to the surface of the host cell. The approximate diversity of each of the completed peptide expression vectors is about 1×10⁹ unique peptides, although libraries of considerably greater diversity can be produced.

### Example 4

### Establishment of Assay Cell Lines for the Identification of APP Effectors

There are four primary requirements for the assay cell line to identify effectors of APP: 1) the cells must possess the natural complement of APP processing enzymes, 2) the cells must constitutively produce APP, 3) the cells are suspension cells to facilitate the high throughput requirement of these experiments, and 4) the screening system needs to mimic the natural physiological conditions associated with APP expression and processing.

APP expressing cell lines are prepared by constructing a mammalian expression vector encoding APP and introducing this expression vector into the parent cell line. Two cell lines, a neuroblastoma cell line and a human embryonic kidney cell line (HEK), are typically used for these assays. Both of these cell lines have been used in APP experimentation (Cedazo-Minguez et al., Neurochem. Int. 35:307-315, 1999; Lopez-Perez et al., J. Neurochem. 73:2056-2062, 1999). The HEK cell line is easier to grow and presents fewer challenges than the neuroblastoma cell line and therefore is preferred for these experiments. The neuroblastoma cell line is an alternative cell line.

To facilitate these experiments, the HEK cells are adapted to spinner culture conditions. Adaptation is accomplished by gradually reducing the amount of serum in the culture medium in static cultures until the cells are capable of growing in serum free media. The cells are then transferred and grown in spinner culture vessels. There is significant cell death with both of these procedures but some cells survive and grow. The cells that grow the best under these conditions outgrow cells that grow less well, producing cells adapted to grow well under serum free spinner culture conditions.

These procedures will be understood by someone skilled in this art. The cDNA encoding APP may be obtained from ATCC or IMAT or alternatively obtained by PCR amplification and verified by DNA sequence analysis. The APP encoding cDNA is inserted into a mammalian expression vector and electroporated into the parental mammalian cell line. The electroporated cells are plated in microtiter plates at a density to allow for cell growth in 50% of the wells under neomycin selection, to provide conditions allowing for clonal isolation. These cell lines are assessed for APP expression by fluorescent microscopy and FACS analysis using anti-APP antibodies as described below.

To successfully implement a screening strategy as described in this application, it is important to be able to manipulate and screen large numbers of cells and peptide sequences. By utilizing suspension culture cells and spinner culture vessels, methods of growing, handling, and utilizing billions of cells per day can be implemented.

### Example 5

### In Vitro Expression of APP and Analysis of Products

Clones of wild type APP and APP containing the Swedish, Arctic, and/or Dutch mutations were expressed in HEK-293 cells. Expression of the mutant clones are useful as controls to show differences in processing in an in vitro screening assay screening assay for effectors of APP processing.

To construct the expression plasmids, a clone encoding the full-length wild type 695 amino acid human APP (Kang et al., Nature, 325:733-736, 1987) was obtained. A 3kb fragment from the NruI site in exon 1 to the SmaI in the 3′UTR was subcloned into the pcDNA3.1 vector. This vector contains a CMV promoter and an SV40 polyadenylation sequence. Similarly, clones encoding APP_{Swe} and APP_{Arc} were used as starting material for the construction of CMV-APP_{Swe} and CMV-APP_{SweArc}.

These constructs were introduced into HEK-293 cells. Cleavage by endogenous secretases results in processing of the APP protein into several fragments. APP protein expression and processing was assessed by Western blot analysis of lysates and conditioned media of mock-transfected (i.e., transfected with a plasmid lacking the APP sequence) and APP_{Swe}-transfected cells. Full-length APP as well as C-terminal fragment C99, Aβ, APPs-α, and APPs-β were detected using 6E10 antibody, which recognizes amino acids 1-16 of Aβ sequence. Full-length APP, C99, and Aβ were found in cell lysates from APPSE transfectants. The identification of Aβ in the cell lysate is believed to be the result of processing within the secretory pathway. APPs-α and Aβ were detected in conditioned medium from APP_{Swe} transfectants. APPs-α and APPs-β were also detected in conditioned medium of cells transfected with the Swedish or Swedish/Arctic mutation using 6E10 antibody and Sw192 antibody, respectively. Antibody Sw192 (Elan Pharmeceuticals) recognizes the amino acids 590-596 of APP_{Swe} only when it has been cleaved by β-secretase.

### Example 6

### Retroviral Infection

The retroviral expression vector is packaged in a packing cell line (Miller et al., Methods Enzymol. 217:581-599, 1993) and utilized to infect the assay cells containing secretase processing enzymes and APP. The fusion protein will enter and pass through the secretory pathway under the influence of the secretory signal concluding with presentation on the cell surface. At the cell surface, the fusion protein comprising the presentation protein, glycine spacers and random amino acid sequence (display complex) becomes attached to the cell via the GPI linkage. Processing of APP by some of the secretases appears to occur during transience through the secretory pathway as well as at the cell surface (Selkoe, Physiolgical Rev. 81:741-767, 2001). The display complex and APP will similarly pass through the secretory pathway and be displayed on the surface of the cell in a common process. Therefore, the random amino acid sequence will be present and the effective peptide will have the opportunity to bind to APP altering its structure within the secretory pathway as well as at the cell surface. FIG. 4 depicts the configuration of the display complex.

### Example 7

### Enrichment of Transfected Cells

Cells vary in the efficiency to take up DNA and express it. In cases where introduction of expressible DNA is not very efficient, it can optionally be possible to enrich for cells that contain the expression vector (e.g., plasmid) and are optimally expressing the DNA. To allow enrichment of cells that contain the genetic library, a label, such as a sequence encoding a marker, is included in the expression vector. Such a marker typically will remain attached to the cell. This sequence encoding the marker can be, for example, a transcription promoter and terminator, a sequence encoding a secretory signal sequence (e.g., CD24), one or more extracellular domains (e.g., V5, FLAG, and the like) and a sequence to tether the marker to the cell surface (e.g., a signal for glycophosphatidylinositol (GPI) anchorage). The placement of peptide libraries between two distinct markers (e.g., V5 and FLAG) can ensure the integrity of the peptide library by selecting only cells that contain both markers in the presentation molecule and that are expressed on the surface of host cells.

The expression vectors described in Example 3 have been used to transfect COS7 cells by electroporation employing conditions to introduce, on average, only one or a few vectors per cell. The cells were placed in culture following transfection and analyzed at various times by FACS to detect the expression of thioredoxin or FLAG on the surface or interior of cells. In each case, a relatively high percentage of cells express the presentation molecules (e.g., thioredoxin - detected using anti-thioredoxin antibody) one day post-transfection, and the molecules persisted over the next week. These results indicate that presentation molecules are expressed at relatively high levels over several days.

Transfected host cells expressing a peptide library were also fixed in para-formaldehyde prior to FACS analysis or selection on magnetic beads. The results demonstrated that the marker epitopes were still accessible to antibody following fixation, indicating that the library peptides were available for binding to target molecules.

Similar experiments demonstrated that K562 cells, transfected by electroporation with plasmid vectors encoding a peptide library, were transfected at approximately 50% efficiency with 80% cell survival. The optimum expression period was between one and two days following transfection. The level of expressed presentation molecule on K562 cells was lower than that on COS7 cells, because K562 cells do not amplify the plasmid vectors as do COS7 cells. However, sufficient presentation molecules were expressed on the surface of K562 cells as demonstrated by localization of labeled anti-FLAG antibody.

The results demonstrate a robust system for displaying peptide libraries on the surface of mammalian cells. The tethering of the presentation molecule via a GPI linkage to the cell and the use of domains from thioredoxin and CD24 lead to the persistent, stable expression of peptide libraries. Further, the placement of the peptides at the N-terminus of the presentation molecule ensures unobstructed accessibility of the peptides to potential target molecules, relatively distant from the cell surface and in a highly favorable hydrophilic environment.

### Example 8

### Prescreening for Peptides that Bind APP

Because of the interest in peptide structures that bind and alter the structure of APP and because not every peptide that binds to APP will modulate proteolytic processing of the protein, however, all peptides that affect processing can be expected to have a high affinity binding for APP, a pre-enrichment of peptides that simply bind APP is performed. Phage display is used for this enrichment process because of the large number of structures that may be generated and screened by this method. Also, phage display selection methods allow increasingly stringent screening conditions to identify high-affinity binding peptides. Phage display peptide libraries can be obtained from commercial sources, i.e., New England Biolabs) or constructed. The peptide sequences can be arranged as linear flexible structures or as constrained loops that present relatively rigid structures. Effector peptides can be as small as 3 or 4 amino acid residues in length, 5, 6, 7 or but to as large as 20 amino acids or more amino acid residues in length.

The APP extracellular domain and N-terminal truncated forms are expressed in bacteria and CHO-DG44 cells or another mammalian host cell, with a His tag for easy purification. These forms can include molecules beginning at nucleotide 457 just 3′ to the Kunitz protease inhibitor domain sequence, another at nucleotide 550, and various shorter forms that exclude the N-terminal functional groups but include the random coil sequence near the β cleavage site to amino acid residues outside of the membrane. The production, stability, and ease of purification of these affinity molecules determines the molecule of choice.

Phage expressing random peptide sequence are exposed to His tag extracellular domain APPs and passed over a His affinity column or exposed to certain forms of His-tag APP molecules previously bound to magnetic beads containing surface Ni²⁺. After 2 or 3 rounds of enrichment the nucleotide sequences encoding the random peptides are excised from the DNA of enriched phage and transferred to the retroviral vector. This enrichment step increases the probability of identification of a peptide that alters APP processing by binding to APP rather than altering the activity of the processing enzymes or causing a change in processing in some other manner. Randomly chosen peptides are also sequenced to evaluate the presence of consensus binding motifs.

### Example 9

### Screening for Effector Peptides

Assay cells are grown in large numbers, approximately a billion or more. The cells are infected with retrovirus encoding a peptide library. After two days of growth, the cells are selected by magnetic bead selection for those cells expressing the display complex utilizing biotinylated anti-presentation protein antibody and strepavidin coated beads (Miltenyi Biotec, Germany). Selection enriches for cells expressing the display complex on the surface of cells. This eliminates cells that are not infected and cells expressing a sequence that is prematurely terminated by a stop codon in the random DNA sequence. Semi-random DNA encoding the random peptide sequence is used to minimize stop codons but does not completely eliminate it (LaBean and Kauffman, Protein Sci. 2:1249-1254, 1993). The frequency of stop codons is related to the length of the random peptide sequence. An amino acid length of about 7, or about 12, or about 16 amino acid residues will typically be used.

Magnetic bead selection also eliminates cells that have been infected, have the capacity to synthesize full length tethered display complex, but do not express sufficient amounts of the display complex due to, for example, integration into a silent expression site in the chromosome. Selection therefore provides cells that are expressing sufficient levels of display protein to be effective in altering the structure of APP. The validity of this configuration has been demonstrated by expressing tethered effector peptide sequence in growth dependent Ba-F3 cells expressing thrombopoietin receptor. The tethered effector peptide confers growth independence to the previously growth dependent cell line. This demonstrates that a tethered peptide can alter the structure of a cell surface receptor causing activation of the receptor and cell survival.

Bead enriched cells are sorted by fluorescent activated cell sorting (FACS) utilizing differentially labeled antibodies recognizing different fragments of APP. To enrich for peptides causing increased α-secretase processing, sorting will be performed based on a change in the ratio of fluorescence between PE labeled antibody (6E10, Pirttila et al., Neurol Sci. 127:90-95, 1994, McLaurin et al., Nature Med. 8:1263-1269, 2002) recognizing amino acid 3-10 in Aβ corresponding to the C-terminal end of APPs-α and FITC labeled anti-p3 antibody (4G8, Pirttila et al., Neurol Sci. 127:90-95, 1994, McLaurin et al., Nature Med. 8:1263-1269, 2002) recognizing amino acid 16-24 of Aβ, corresponding to the N-terminal end of p3 (See FIG. 5). Control cells infected with the expression vector without random peptide sequence provide a control PE/FITC ratio. Cells with a lowered PE/FITC fluorescent ratio are collected.

Similarly, cells are sorted for peptides causing a reduction in β-secretase processing by collecting cells with increased ratio of FITC labeled anti-APPs-β. (A3 or IG7 specific to APP midregion, Koo et al., J. Biol. Chem. 269:17386-17389, 1994) to PE labeled antibody (6E10) anti-APPs-α fluorescence (See FIG. 5).

To set up and test the APP effector assay system, reagents and conditions are used that influence the amount of cleavage at the α and β sites to demonstrate the sensitivity and validity of the assay. For example, assay cells are transfected with expression vectors encoding either α or β-secretase. This increases processing at these sites and is revealed by the cellular assay. Once enriched cells are obtained by FACS, the DNA encoding the random peptide is recovered from the cells by PCR amplification and recloned into the peptide library expression vector. These are procedures known to someone trained in this art. The isolated clones are amplified in bacteria, repackaged in the retroviral packing cells, used to infect naive assay cells, and the enrichment process is repeated until clones encoding true effector peptides are obtained. DNA sequence analysis of the clones encoding the random peptide sequence reveals the sequence of the effector peptide.

Once one or more effector peptides have been identified, the effector peptides can be tested for their ability to effect the structure of APP. Methods for the binding of the effector peptides are well known and include methods described above for prescreening the peptide libraries.

### Example 10

### Characterization of Effector Peptide

The effector peptide is characterized to show that soluble Aβ is reduced in cultures under the influence of the effector peptide. ELISA and Western blot analysis of culture medium from assay cells plus and minus expression of effector peptide can be used to verify the desired effect.

In one assay, an effector peptide that increases α-secretase processing of APP (herein “EMα peptide”) is coexpressed with human APP in HEK293 cells or SH-SY5Y cells. The expression level of full length APP is determined in the presence or absence of the effector peptide by Western blot analysis (antibody 6E10 or 22C 11). Furthermore, efficacy testing of the effector peptide assesses its capacity to reduce protofibrils and monomeric soluble Aβ1-40 and Aβ1-42 levels in the media after peptide expression. Levels of AP protofibrils and Aβ1-40/42 is determined by ELISA, using different antibodies. The commercially available antibodies (i e., Biosource/QCB cat #44-348 and 44-344) is used to specifically quantitate Aβ40 and Aβ42, respectively.

Similarly, the effect of peptides that decrease P-secretase processing of APP (herein “EMβ peptide”) on the expression level of APP and Aβ40 and Aβ42 is characterized in a similar manner.

The effect of EMα and EMβ peptides on nearby processing activities is also characterized. In cells expressing an EMα peptide, the release of APPsβ, APPsγ and as well as the C-terminal fragments CT99, is compared to the release of these fragments when the EMα peptide is not expressed. A different fragment pattern indicates interference. In analogy, the release of APPsα, APPsγ, p3, and CT 57/59 is determined with and without expression of the EMβ peptide.

Whether the specificity or efficacy of an EMα or EMβ peptide is altered in familial AD mutations is also determined. The following APP mutations are used for this study:

(a) Swedish (Lys670Asn; Met671Leu), 2 amino acids N-terminally to the β-cleavage site;

(b) Flemish (Ala692Gly), 5 amino acids C-terminally to the α-cleavage site;

(c) Dutch (Glu693Gin), 6 amino acids C-terminally to the α-cleavage site;

(d) Arctic (Glu693Gly), 6 amino acids C-terminally to the α-cleavage site; and

(e) Iowa (Asp694Asn), 7 amino acids C-terminally to the α-cleavage site.

Also assessed is whether an APP mutation affects the affinity or association kinetics of an EMα or EMβ peptide to the APP protein and APP processing rates. Binding studies are performed by incubating a radiolabelled EMα or EMβ peptide with HEK293 cells expressing wild-type APP or mutated forms of APP.

Processing at the β-site is significantly increased when APP contains the Swedish mutation. (See Mullan et al., Nat. Genet. 1:345-347, 1992.) For example, in transgenic mice expressing human APP with the Swedish mutation (hamster prion promoter-hAPP_{Swe}), SDS soluble Aβ40 and Aβ42 peptides are increased from 21 and 6 pmol/g at 5 months of age to 11,100 and 2,000 pmol/g at 21 months, respectively. (Kawarabayashi et al., J. Keurosci. 15:372-3 81, 2001). Co-transfection of an EMβ peptide with APPSwe indicates whether the Swedish mutation affects the EMβ peptide's inhibitory action on the β-site cleavage or not. Similarly, also assessed are the effects of APP mutations (b)-(e) near the α-site, see supra, on EMα peptide-stimulated α-cleavage.

The efficacy of an effector peptide (EP) in reducing the amount of Aβ can also be assessed in a suitable transgenic animal model that over expresses Aβ, for example Tg(HuAPP695.K670N/M671L)2567 or PDAPP. (See also, e.g., Examples 11 and 12, infra.)

Additional characterization involves identification of the target of the peptide. These experiments utilize the display complex (presentation protein with tethered peptide) as well as the peptide alone as affinity labels. Binding of the peptide to APP is assessed by labeling the peptide and assessing binding to the extracellular domain of APP. Fluorescent labeled peptide is also used to assess binding to the assay cells expressing APP, with a comparison to control assay cells not expressing APP.

To assess binding to processing enzymes, labeled peptide is used to determine peptide binding to parental assay cells and comparing peptide binding to cells known to not express the processing enzymes. Additional characterization can comprise labeled peptide mixed with solubilized cell lysates and fractionated by ion exchange and size exclusion chromatography, 2-D electrophoresis, and mass spectrum analysis of protein spots to determine binding to other cell components. It is possible that an effector peptide binds and alters the function of another cellular molecule causing a reduction in Aβ without binding to APP or without altering the processing of other important biological molecules.

### Example 11

### In Vivo Efficacy Testing of Effectors of APP Processing in Transgenic Mice Direct Peptide Administration

In vivo efficacy testing of an EMα peptide will assess its capacity to stimulate APPα-secretase cleavage rates and lowering of Aβ protofibrils and Aβ40/42 levels in the brain. Protofibril levels and brain distribution are assayed by ELISA and immunohistochemistry using a protofibril-specific monoclonal antibody. Plaque burden is determined using standard procedures involving perfusion and fixation of brain tissue in 4% paraformaldehyde and immunostaining with Aβ-antibody (e.g., with 6E10 as previously described (see Nilsson et al., J. Neurosci. 21:1444-1451, 2001)).

Initial testing of EMα and EMβ peptides involves direct administration of the peptide by subcutaneous or intraperitoneal injections to Tg mice for measuring blood-brain-barrier passage properties. Passage is assessed by determination of the EMα or EMβ peptide in CSF and brain homogenate after brain perfusion using an anti-EMα or anti-EMβ peptide ELISA method, respectively. Different dose levels are tested and correlated to peptide levels obtainable in brain and CSF. In vitro experiments provide information on the concentrations of the EMα or EMβ peptide required to obtain significant stimulation of α-secretase or inhibition of β-secretase, respectively. An alternative and more sensitive approach is to radiolabel (iodinate) the peptides and determine their radioactivity in CSF and brain homogenate. Although this method is more sensitive, it can give erroneous results due to modification of the peptide. Furthermore, half-life for the EMα or EMβ peptide is determined in CSF, brain, and serum using standard procedures, as a guidance for dosing frequency in the animal efficacy studies. A constant CSF/brain concentration of the EMα or EMβ peptide over time is typically desired. If the EMα or EMβ peptide shows satisfactory passage properties, then efficacy testing is performed. However, if passage properties of the EMα or EMβ peptide are not satisfactory, then efficacy testing by direct s.c or i.p. administration of the peptides is not be performed. An alternative approach is to deliver the peptides by i.c.v. using an osmotic pump (Alzet) or to directly express the peptide in the brain of Tg mice (see infra).

In one study, efficacy testing of the EMα or EMβ peptide is by direct peptide administration. Efficacy testing by direct administrations involves administration of the EMα or EMβ peptide for 4-6 months to Tg mice, with reduction of Aβ40/42 and Aβ protofibril levels as an endpoint. A reduction of Aβ levels likely leads to a reduction of Aβ protofibrils, since formation of protofibrils are dependent on Aβ1-40 and Aβ1-42 concentrations. A suitable mouse strain is mThy1-hAPP_{Swe}, which carries a transgene coding for the 695-amino acid isoform of human Amyloid Precursor Protein (APP) containing the Swedish mutation which is an ongoing project in our laboratory and similar to a well-established AD model (see Hsiao et al., Science 274:99-102, 1996). Thus, the mThy1-hAPP_{Swe} likely shows a significant time-dependent increase of Aβ1-40 and Aβ1-42, large amyloid depositions, aged-correlated elevation of brain cholesterol and ApoE, as well as altered synaptic efficacy (see Kawarabayashi et al., J. Neurosci. 15:372-381, 2001). This “Hsiao-APP mouse” model has also been shown to develop behavioral deficits (see Westerman et al., J. Neurosci. 22:1858-1867, 2002).

Efficacy testing is also performed in a double transgenic model (mThy1-haPP_{SweArc}), containing both the Swedish and Arctic mutation. This model is developed to establish a model that produces high levels of AβArc protofibrils in the brain. Aβ protofibrils are neurotoxic (see Hartley et al., J. Neurosci. 19:8876-8884, 1999) and affects early synaptic function (see Selkoe, Science 298:789-791, 2002). Nilsberth et al. (Nat. Neurosci. 4:887-893, 2001) has shown that the Arctic mutation confers higher protofibril stability and rate of formation, leading to early onset of AD.

Short-term administration (2-3 weeks) of the EMα or EMβ peptide at an early age, prior to any amyloid deposition and when the Aβ levels shows little age-dependent increase, assesses their mechanistic ability to alter APP processing in vivo. Further, the prophylactic effect of the EMα or EMβ peptide is evaluated in young Tg mice by long-term administration starting prior to the onset of amyloid deposition and continuing until a time point when the transgenic mouse model is known to display robust amyloid deposition. Finally, the therapeutic efficacy of the EMα or EMβ peptide is examined by long-term administration to old mice after the onset of amyloid deposition. Various measures of arnyloid pathology are determined to assess the efficacy and safety (e.g., Aβ and Thioflavine S plaque burden, extractable Aβ1-40 and Aβ1-42, Aβ protofibrils as assessed by sequential extraction (Tris buffered Saline, Triton X-100, SDS and formic acid), and ELISA). Secondary tissue damage such as neurodegenerative changes (neuritic dystrophy, synaptic loss, oxidative damage) is also analyzed preferentially with immunohistochemistry and quantitative image analysis. Traditional markers of cerebral inflammation such as GFAP (astrogliosis) and MAC-1/CD11 and IL-1 (microgliosis) are determined, as well as other pro-inflammatory cytokines such as γ-IFN, IL-2, and IL-6 and anti-inflammatory cytokines such as TGF-α, IL-4, and IL-10. Prevention of cognitive dysfunction is studied in the Radial Arm Water Maze, which is more sensitive to “episodic-like” memory than the classical Morris Water Maze.

### Example 12

### In Vivo Efficacy Testing of Effectors of APP Processing in Transgenic Mice-Peptide Expression In Vivo

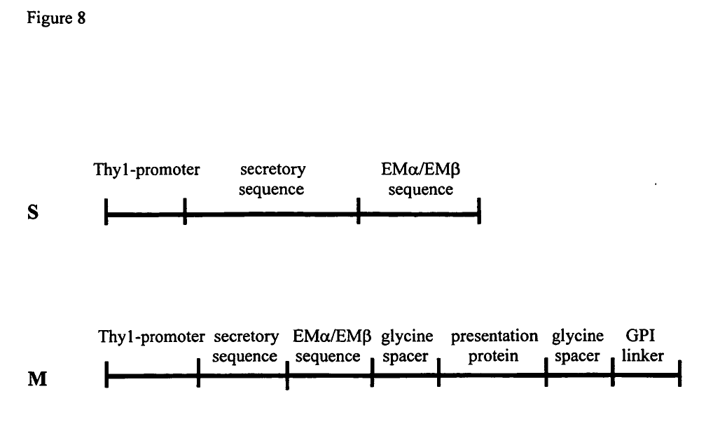

If the blood-brain-barrier passage properties of the EMα or EMβ peptide are not satisfactory, an alternative strategy for efficacy testing is performed by direct in vivo expression of the effector peptide in brains of transgenic mice. Two different expression vector constructs are generated, both in which an EMα or EMβ peptide coding sequence is expressed in neurons using, e.g., the Thy-1 promoter. One DNA construct (herein Thy1-Emα/EMβ_{S}) is engineered so that the effector peptide is expressed in a secreted (S) form in the brain; the other DNA construct (herein Thy1-Emα/EMβ_{M}) contains a GPI-linker and thereby targets the expressed peptide to neuronal membranes (M). (See FIG. 8.) Thy1-Emα/EMβ_{S} and Thy1-Emα/EMβ_{M} transgenic mice are then generated using standard procedures.

Thy1-Emα/EMβₛ and Thy1-Emα/EMβ_{M} transgenic mice are crossed with Thy1-hAPP_{Swe} and mThy1-hAPP_{SweArc} transgenic mice to determine the efficacy of the EMα or EMβ peptide in vivo. These multiple transgenic models are also used to characterized effect of the peptide on compartmentalization of APP processing. The effect of secreted or membrane-bound (e.g., ER-, Golgi-, plasma membrane-bound) EMα peptide on APPα-secretase cleavage rates are determined. Similarly, the effect of secreted or membrane-bound EMβ peptide on β-secretase cleavage rates are also examined. These studies provide important in vivo data, such as, e.g., whether increased α-site processing or deceased β-site processing translates into a reduction in Aβ protofibril and Aβ40/42 levels, less amyloid depositions, less inflammation and/or improved cognitive functions.

The previous examples are provided to illustrate, but not to linit, the scope of the claimed inventions. Other variants of the inventions will be readily apparent to those of ordinary skill in the art and encompassed by the appended claims. All publications, patents, patent applications and other references cited herein and are also incorporated by reference herein in their entirety.

What is claimed is:

1. A method for identifying an agent that alters processing of β-amyloid precursor protein (APP) comprising:
contacting the agent with an animal host cell that expresses APP and at least one APP processing enzyme, and
detecting altered APP processing to identify the agent that alters the processing of APP.

2. The method of claim 1, wherein detecting the altered APP processing comprises assessing the relative presence or absence of at least one species of APP fragment on the surface of the host cell.

3. The method of claim 2, wherein the at least one species of APP fragment is APPs-α, APPs-βP, or APPs-γ.

4. The method of claim 1, wherein the at least one APP processing enzyme is α-secretase, β-secretase, or γ-secretase.

5. The method of claim 1, wherein the altered APP processing results in a decreased production of an amyloid β-protein (Aβ).

6. The method of claim 5, wherein the amyloid β-protein is associated with an increased risk of Alzheimer's disease.

7. The method of claim 6, wherein the amyloid β protein associated with an increased risk of Alzheimer's disease is Aβ1-39, Aβ1-40, or Aβ1-42.

8. The method of claim 1, wherein the agent is from a compound library.

9. The method of claim 8, wherein the compound library is a combinatorial chemical library.

10. The method of claim 8, wherein the compound library is a natural products library.

11. The method of claim 8, wherein the compound library is a peptide library.

12. The method of claim 1, wherein the agent is a small molecule.

13. The method of claim 1, wherein the agent is a biomolecule.

14. The method of claim 13, wherein the biomolecule is a peptide.

15. The method of claim 14, wherein the peptide is produced by transcription and translation from an oligonucleotide encoding the peptide.

16. The method of claim 15, wherein the oligonucleotide has a length of about 18 to about 120 nucleotides.

17. The method of claim 15, wherein the oligonucleotide has a length of about 36 to about 60 nucleotides.

18. The method of claim 15, wherein the contacting of the peptide with the host cell comprises introducing an expression vector, the expression vector comprising the oligonucleotide encoding the peptide, into the host cell, the host cell thereby expressing and displaying the peptide within a secretory pathway and on an extracellular cell surface.

19. The method of claim 15, wherein the oligonucleotide is from an expression library comprising a plurality of oligonucleotides, at least of majority of the oligonucleotides having different sequences encoding different peptides.

20. The method of claim 19, wherein the sequence of the plurality of oligonucleotides is randomized.

21. The method of claim 19, wherein the expression library is pre-enriched for oligonucleotides encoding peptides that specifically bind to APP.

22. The method of claim 19, wherein the contacting of the peptide with the host cell comprises introducing the expression library into a first plurality of animal host cells that express APP and at least one APP processing enzyme, the host cells thereby expressing and displaying the different peptides within a secretory pathway and on an extracellular cell surface.

23. The method of claim 22, further comprising:
selecting from the first plurality of host cells displaying the different peptides a first subset of host cells that exhibit altered APP processing; and
identifying from the first subset of host cells a first sub-library of the expression library comprising at least one oligonucleotide that encodes the peptide that alters the processing of APP.

24. The method of claim 22, wherein the first plurality of host cells displaying the different peptides have been enriched using a selectable marker.

25. The method of claim 24, wherein the selectable marker is V5, FLAG, or thioredoxin.

26. The method of claim 24, wherein the enrichment comprises magnetic bead selection.

27. The method of claim 24, wherein the enrichment comprises selection by fluorescence-activated cell sorting.

28. The method of claim 24, wherein the host cells expressing and displaying the different peptides on the extracellular cell surface express a high copy number of the different peptides.

29. The method of claim 15, wherein the peptide is displayed as a fusion protein with a presentation molecule.

30. The method of claim 29, wherein the presentation molecule is CD24.

31. The method of claim 29, wherein the presentation molecule is IL-3 receptor.

32. The method of claim 29, wherein the presentation molecule is thioredoxin.

33. The method of claim 29, wherein the fusion protein further comprises a marker epitope.

34. The method of claim 33, wherein the marker epitope is polyhistidine, V5, FLAG, or myc

35. The method of claim 29, wherein the fusion protein further includes a signal for a glycophosphatidylinositol (GPI) anchorage.

36. The method of claim 1, wherein the animal host cell is a mammalian host cell.

37. The method of claim 1, wherein the animal host cell is a recombinant host cell.

38. The method of claim 37, wherein the animal host cell is an isolated cell.

39. The method of claim 1, wherein the agent is contacted with the host cell under substantially physiological conditions.

40. The method of claim 39, wherein the substantially physiological conditions comprise the presence of a complex biological fluid.

41. The method of claim 40, wherein the complex biological fluid is blood, serum, plasma, or cerebral spinal fluid (CSF).

42. The method of claim 2, wherein the assessment of the relative presence or absence of at least one species of APP fragment on the cell surface comprises contacting the host cell with at least one detectably labeled marker that specifically binds to the at least one species of APP fragment and detecting the bound, labeled marker.

43. The method of claim 42, wherein the at least one marker is an antibody that binds to a predetermined epitope of APP or APP fragment.

44. The method of claim 43, wherein the assessment of the relative presence or absence of at least one species of APP fragment on the cell surface further comprises determining a ratio of the detection signals of at least two labeled antibodies specific for at least two different epitopes of APP or an APP fragment.

45. The method of claim 1, wherein the agent is an allosteric effector of APP.

46. The method of claim 1, wherein the detecting altered APP processing on the surface of the host cell comprises the use of a flow sorter.

47. The method of claim I, further comprising
administering the agent to an animal and monitoring the animal for an effect on a physiological condition associated with altered APP processing.

48. The method of claim 47, wherein the administration is by direct injection or by oral administration.

49. The method of claim 47, wherein the agent is a peptide and the animal is a transgenic mouse comprising an expression construct that encodes the peptide, wherein the expression construct comprises, in operative combination, (a) a promoter, (b) a secretory sequence, (c) a nucleotide sequence encoding the peptide, and (d) a transcription termination sequence; and wherein the transgenic mouse expresses detectable levels of the peptide in vivo.

50. The method of claim 49, wherein the expression construct encodes a presentation molecule that is anchored to a cell membrane, the expression construct further comprising
(e) a nucleotide sequence encoding a presentation protein, said presentation protein-encoding sequence located 3′ to the peptide-encoding sequence, and
(f) a nucleotide sequence encoding a transmembrane domain or a GPI linker, said transmembrane domain or GPI linker sequence located 3′ to the presentation protein-encoding sequence and 5′ to the transcription termination sequence.

51. The method of claim 47, wherein the effect on a physiological condition associated with altered APP processing is a decrease in the levels of Aβ protofibrils or Aβ40/42.

52. The method of claim 47, wherein the effect on a physiological condition associated with altered APP processing is plaque inhibition.

53. A method for identifying a peptide that alters processing of β-amyloid precursor protein (APP) comprising:
introducing an expression library comprising a plurality of oligonucleotides, at least a majority of the oligonucleotides having different sequences encoding different peptides, into a first plurality of animal host cells that express APP and at least one APP processing enzyme, the host cells thereby expressing and displaying the different peptides within a secretory pathway and on an extracellular cell surface;
selecting from the first plurality of host cells displaying the different peptides a first subset of host cells that exhibit altered APP processing; and
identifying from the first subset of host cells a first sub-library of the expression library comprising at least one oligonucleotide that encodes the peptide that alters the processing of APP.

54. The method of claim 53, wherein the animal host cell is a mammalian host cell.

55. The method of claim 53, wherein the animal host cell is a recombinant host cell.

56. The method of claim 53, wherein the animal host cell is an isolated cell.

57. The method of claim 53, wherein the first plurality of host cells display the different peptides under substantially physiological conditions.

58. A method for identifying a peptide that alters processing of β-amyloid precursor protein (APP) comprising:
(1) pre-enriching an expression library comprising a plurality of oligonucleotides, at least a majority of the oligonucleotides having different sequences encoding different peptides, for at least one oligonucleotide that encodes a peptide that specifically binds to APP, the pre-enrichment comprising the steps of
(a) introducing the expression library into a phage display vector which can express the peptides encoded by the oligonucleotide sequences on the surface of the phage;
(b) expressing the different peptides on the surface of the phage;
(c) selecting a subset of phage particles that express peptides that specifically bind APP or an N-terminally truncated APP, said N-terminally truncated APP having the α- or β-secretase cleavage site; and
(d) recovering the oligonucleotide sequences from the selected phage particles to form a pre-enriched expression library;
(2) introducing the pre-enriched expression library into a first plurality of animal host cells that express APP and at least one APP processing enzyme, the host cells thereby expressing and displaying the at least one APP-binding peptide within a secretory pathway and on an extracellular cell surface;
(3) selecting from the first plurality of host cells displaying the at least one APP-binding peptide a first subset of host cells that exhibit altered APP processing; and
(4) identifying from the first subset of host cells a first sub-library of the pre-enriched expression library comprising at least one oligonucleotide that encodes the peptide that alters the processing of APP.

59. A method for identifying a peptide that alters processing of β-amyloid precursor protein (APP) comprising:
introducing an expression library comprising a plurality of oligonucleotides, at least a majority of the oligonucleotides having different sequences encoding different peptides, into a first plurality of animal host cells that express APP and at least one APP processing enzyme, the host cells thereby expressing and displaying the different peptides within a secretory pathway and on an extracellular cell surface;
selecting from the first plurality of host cells displaying the different peptides a first subset of host cells that exhibit altered APP processing; wherein the altered APP processing is determined by assessing the relative presence or absence of at least one species of APP fragment on the surface of the host cells displaying the different peptides by contacting the host cells with at least one detectably labeled marker that specifically binds to the at least one species of APP fragment and detecting the bound labeled marker; and
identifying from the first subset of host cells a first sub-library of the expression library comprising at least one oligonucleotide that encodes the peptide that alters the processing of APP.

60. A method for identifying a peptide that alters processing of β-amyloid precursor protein (APP) comprising:
introducing an expression library comprising a plurality of oligonucleotides, at least a majority of the oligonucleotides having different sequences encoding different peptides, into a first plurality of animal host cells that express APP and at least one APP processing enzyme, the host cells thereby expressing and displaying the different peptides within a secretory pathway and on an extracellular cell surface under substantially physiological conditions;
selecting from the first plurality of host cells displaying the different peptides a first subset of host cells that exhibit altered APP processing; wherein the altered APP processing is determined by assessing the relative presence or absence of at least one species of APP fragment on the surface of the host cells displaying the different peptides by contacting the host cells with at least one detectably labeled marker that specifically binds to the at least one species of APP fragment and detecting the bound labeled marker; and
identifying from the first subset of host cells a first sub-library of the expression library comprising at least one oligonucleotide that encodes the peptide that alters the processing of APP.

61. The agent identified by the method according to claim 14, wherein the agent is converted into a peptidometic, a isosteric replacement compound, a D-amino acid analog, or a non-peptidyl compound.

62. The agent identified by the method according to claim 1, wherein the agent is modified to facilitate passage through the blood brain barrier.

63. The agent identified by the method according to claim 1, wherein the agent is formulated for parenteral, oral, sustained release, topical, intranasal or inhalation use.


SEQUENCE LISTING (5 sequences)

SEQ ID NO: 1 - protein, 8 aa, Artificial Sequence
  chemically synthesized
DLYDDDDK

SEQ ID NO: 2 - protein, 11 aa, Artificial Sequence
  myc epitope
EQKLISEEDLN

SEQ ID NO: 3 - protein, 14 aa, Artificial Sequence
  v5 Epitope
GKPIPNPLLGLDST

SEQ ID NO: 4 - protein, 8 aa, Artificial Sequence
  the FLAG tag
DYKDDDDK

SEQ ID NO: 5 - protein, 5 aa, Artificial Sequence
  Factor Xa amino acid substrate sequence
  MISC_FEATURE (5)..(5): X=any amino acid
IEGRX